(19) United States
(12) Patent Application Publication
(10) Pub. No.: US 2025/0339797 A1
(43) Pub. Date: Nov. 6, 2025

(54) FILTER ASSEMBLY INCLUDING ELLIPTICAL SEALING INTERFACE

(71) Applicant: CUMMINS FILTRATION INC., Nashville, TN (US)

(72) Inventors: Wassem Abdalla, Fishers, IN (US); Pravin Shantinath Kadam, Maharashtra (IN); Jayant Singh, Pune (IN); Sonia Rajendra Kasbekar, Pune (IN); Gerard Malgorn, Ergue Gaberic (FR); Hariprasad Mohan Bhalerao, Pune (IN)

(73) Assignee: CUMMINS FILTRATION INC., Nashville, TN (US)

(21) Appl. No.: 18/869,183

(22) PCT Filed: May 31, 2023
(86) PCT No.: PCT/US2023/023925

§ 371 Date: Nov. 25, 2024

(30) Foreign Application Priority Data
May 31, 2022 (IN) 202241031195

(51) Int. Cl. B01D 35/30; B01D 29/21; B01D 29/23; B01D 35/00; F02M 37/34

(52) U.S. Cl. CPC B01D 35/306; B01D 29/21; B01D 29/232; B01D 35/005; F02M 37/34; B01D 2201/295; B01D 2201/302; B01D 2201/4061; B01D 2201/4092

(57) ABSTRACT

A filtration system is provided. The filtration system includes a filter head and a filter cartridge removably coupled to the filter head. The filter head includes an outer flange and a center port, where the center port is positioned radially within the outer flange. The filter cartridge includes a shell housing and a filter element removably positioned within the shell housing. The shell housing is configured for removably coupled to the filter head. The filter element includes filter media and an endcap coupled to the filter media. The endcap includes a center pipe and an alignment projection extending radially inward from an inner surface of the center pipe. The alignment projection is configured to engage with a portion of the filter head to prevent the center pipe from rotating relative to the shell housing while the filter cartridge is being coupled to the filter head.

### CROSS-REFERENCE TO RELATED APPLICATIONS

This Application is a National Phase Application based on PCT Application No. PCT/US2023/023925, filed May 31, 2023, which claims the benefit of and priority to Indian Provisional Application No. 202241031195, filed May 31, 2022. The contents of these applications are incorporated herein by reference in their entirety.

### TECHNICAL FIELD

The present disclosure relates generally to filtration systems for filtering fluids such as fuel.

### BACKGROUND

Internal combustion engines generally combust a mixture of fuel (e.g., diesel, gasoline, natural gas, etc.) and air. Prior to entering the engine, the fuel is typically passed through a filter element to remove particulate matter (e.g., dust, metal particles, debris, etc.), and may also separate water from the fuel. Such fuel-water separator filter assemblies generally separate water at an outer diameter of the filter element, and the separated water accumulates in a water reservoir located below the filter element. The water reservoir is generally open to the outer diameter of the filter element. When such filter assemblies are included in vehicles, movement of the vehicles may cause the water to splash and contact the outer diameter of the filter element. This action can wet the filter media of the filter element, which negatively impacts performance of the filter element.

### SUMMARY

At least one embodiment related to a filtration system. The filtration system includes a filter head and a filter cartridge removably coupled to the filter head. The filter head includes an outer flange and a center port, where the center port is positioned radially within the outer flange. The filter cartridge includes a shell housing and a filter element removably positioned within the shell housing. The shell housing is configured for removably coupled to the filter head. The filter element includes filter media and an endcap coupled to the filter media. The endcap includes a center pipe and an alignment projection extending radially inward from an inner surface of the center pipe. The alignment projection is configured to engage with a portion of the filter head to prevent the center pipe from rotating relative to the shell housing while the filter cartridge is being coupled to the filter head.

Another embodiment relates to a filter element. The filter element includes filter media, a first endcap, and a center pipe. The filter media includes a first media end and a second media end opposite the first media end. The first endcap is coupled to the first media end and a second endcap coupled to the second media end. The center pipe extends axially from the first endcap in a direction opposite the second media end, and the center pipe includes a pipe sidewall extending circumferentially about a central opening and the center pipe includes an alignment projection extending radially from the pipe sidewall into the central opening.

Another embodiment relates to a filtration system. The filtration system comprises a filter head. The filter head comprises an outer flange and an engagement element. The filtration system comprises a filter cartridge. The filter cartridge comprises a shell housing comprising a pocket. The filter cartridge comprises a filter element positioned within the shell housing. The filter element comprises a filter media and an endcap coupled to the filter media. The endcap comprises a main body. The endcap comprises a support projection extending from a perimeter of the main body positionable within the pocket of the shell housing so as to prevent rotation of the filter element relative to the shell housing. The endcap comprises an alignment element disposed radially inward from the perimeter of the main body. The alignment element is structured to engage with at least a portion of the engagement element of the filter head to prevent rotation of the filter head relative to the filter element. The filtration system comprises a collar configured to couple the filter head with the filter cartridge.

This summary is illustrative only and should not be regarded as limiting.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a side cross-sectional view of a filter assembly having a filter cartridge coupled to a filter head, according to an example embodiment.

FIG. 2 is a top perspective view of a first endcap of a filter element of the filter cartridge of FIG. 1.

FIG. 3 is a detailed top view of the first endcap of FIG. 2.

FIG. 4 is a top perspective view of a shell housing of the filter cartridge of FIG. 1 with the filter element removed.

FIG. 5 is a top perspective view of the shell housing of FIG. 4, according to an example embodiment.

FIG. 6 is a bottom perspective view of the filter head of FIG. 1 with the shell housing removed.

FIG. 7 is a detailed cross-sectional view of an upper portion of the filter assembly of FIG. 1.

FIG. 8 is a detailed cross-sectional view of the filter assembly of FIG. 1 taken at line AA, the filter assembly having the filter cartridge installed.

FIG. 9 is bottom perspective view of the filter head of FIG. 6, according to an example embodiment.

FIG. 10 is a detailed cross-sectional view of the filter assembly of FIG. 1 taken at line AA, the filter assembly having the filter cartridge installed, according to an example embodiment.

FIG. 11 is a detailed cross-sectional view of a bottom portion of the shell housing of FIGS. 3 and 4 taken at line CC, according to an example embodiment.

FIG. 12 is a top perspective view of a second endcap of the filter element of the filter cartridge of FIG. 1.

FIG. 13 is a side cross-sectional view of the filter assembly of FIG. 1 with the filter element partially installed within the shell housing, according to an example embodiment.

FIG. 14 is a bottom perspective view of the second endcap of the filter element of the filter cartridge of FIG. 1, according to an example embodiment.

FIG. 15 is a top perspective view of the shell housing of the filter cartridge of FIG. 1, according to an example embodiment.

FIG. 16 is a side cross-sectional view of the filter cartridge of FIG. 1, according to an example embodiment.

FIG. 17 is a side cross-sectional view of the filter cartridge of FIG. 1, according to another example embodiment.

FIG. 18 is a side cross-sectional view of the filter cartridge of FIG. 1, according to another example embodiment.

FIG. 19 is a top perspective view of the first endcap of the filter element of the filter cartridge of FIG. 18.

FIG. 20 is a top perspective view of a support tube of the filter element of the filter cartridge of FIG. 18.

FIG. 21 is a detailed cross-sectional view of the filter cartridge of FIG. 1, according to another example embodiment.

FIG. 22 is an exploded view of the first endcap and the support tube of the filter element of the filter cartridge of FIG. 21.

FIG. 23 is a detailed cross-sectional view of the filter cartridge of FIG. 1, according to another example embodiment.

FIG. 24 is an exploded view of the first endcap and a first tube portion of the filter element of the filter cartridge of FIG. 23.

FIG. 25 is a detailed cross-sectional view of an upper portion of a filter assembly, according to another example embodiment.

FIG. 26 is a cross-sectional view of the filter assembly of FIG. 25 without a filter head.

FIG. 27 is a cross-sectional view of a filter cartridge of the filter assembly of FIG. 25.

FIG. 28 is a top perspective view of a first endcap of a filter element of the filter assembly of FIG. 25.

FIG. 29 is a detailed top view of a pipe plate of the first endcap of FIG. 28.

FIG. 30 is a top perspective view of an upper portion of the filter assembly of FIG. 25 without a filter head.

FIG. 31 is a bottom perspective view of a filter head of the filter assembly of FIG. 25, according to an example embodiment.

FIG. 32 is a detailed cross-sectional view of an upper portion of the filter assembly of FIG. 25.

FIG. 33 is a top perspective view of a collar of the filter assembly of FIG. 25, according to an example embodiment.

FIG. 34 is a detailed cross-sectional view of an upper portion of a filter assembly, according to another example embodiment.

FIG. 35 is a top perspective view of a first endcap of a filter element of the filter assembly of FIG. 34.

FIG. 36 is a bottom perspective view of a filter head of the filter assembly of FIG. 34, according to an example embodiment.

FIG. 37 is a detailed cross-sectional view of the upper portion of the filter assembly of FIG. 34.

### DETAILED DESCRIPTION

Following below are more detailed descriptions of various concepts related to, and implementations of, methods, apparatuses, and systems for sealing and retaining a filter element within a shell housing. The various concepts introduced above and discussed in greater detail below may be implemented in any of numerous ways, as the described concepts are not limited to any particular manner of implementation. Examples of specific implementations and applications are provided primarily for illustrative purposes.

Internal combustion engine systems require a clean source of fuel to power the engine. Unfiltered fuel may include dirt, metal particles, and other solid contaminants that can damage fuel injectors and other engine components. In order to protect the injectors, many internal combustion engine systems include fuel filtration systems, which filter the fuel to remove any solid materials before passing the fuel to the injectors. The filtration system may include a filter cartridge and a filter head. In operation, the filtration system directs the fuel through the filter cartridge, which includes a filter element that captures any solid particulate entrained in the fuel. The performance of the filtration system depends, among other factors, on the structure of the filter cartridge and the materials used to construct the filter cartridge (e.g., the materials used to produce a filter element for the filter cartridge, the specifications of the filter element and the media pack such as the flow area of the media pack, the pleat depth of the media pack, and other factors).

Over time, accumulated particulate on the filter cartridge (e.g., carbon, dust, metal particles, etc.) can increase the pressure drop across the filter cartridge (and, correspondingly, a pressure drop across a fuel delivery system for the engine). In order to reduce the pressure drop, the filter cartridge can be removed from the filtration system and replaced with a clean filter cartridge. In some embodiments, the filter element of the filter cartridge may be removed and replaced with a new filter element.

Implementations herein relate to methods and systems of facilitating a unique sealing interface between a filter cartridge and a filter head. The unique sealing interface between the filter cartridge and the filter head may comprise a non-circular interface that does not have perfect rotational symmetry. Accordingly, the filter cartridge must be specifically oriented relative to the filter head to allow a sealing engagement to form between the filter head and the filter cartridge. The filter head includes an alignment post that engages with an alignment tab of the filter element to facilitate alignment of the filter cartridge with the filter head. As the filter cartridge is threaded to the filter head, the alignment post stops rotation of an opening of the filter cartridge relative to the filter head such that the opening moves axially toward the filter head while the rest of the filter cartridge is rotated in the “tightening” direction. As referred to herein, “rotation,” “rotation about,” and “rotation around” refers to spinning about an axis, such as the earth on its axis. As the embodiments of the filter system described herein may provide one or more benefits including, for example, (1) preventing the use of filter cartridge and filter elements having circular central openings, (2) facilitating sealing between a filter head and a filter cartridge/element having non-circular openings, and (3) ensuring alignment between two non-circular sealing surfaces quickly and without needing additional tools.

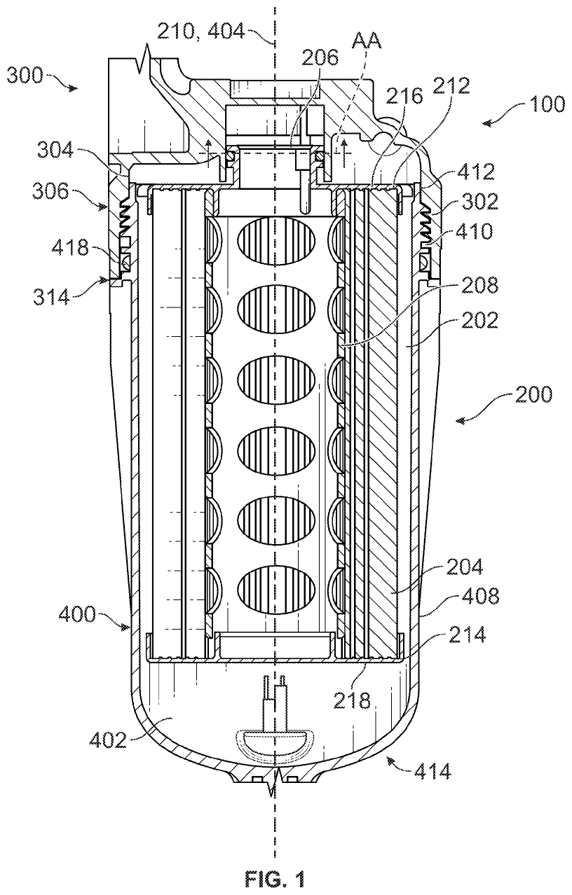

Turning now to FIG. 1, a cross-sectional view of a first example liquid filtration system is shown as a system 100. The system 100 may be used to filter a fluid provided to an internal combustion engine. The fluid may be a fuel, an engine oil, a hydraulic oil, or another lubricant. In the example embodiment of FIG. 1, the system 100 is a fuel filtration system for a diesel engine that uses diesel fuel to drive the combustion process. The system 100 is configured to be mounted on the diesel engine. In other embodiments, the system 100 may be configured to be mounted remotely from the engine (e.g., on a vehicle chassis, etc.).

As shown in FIG. 1, the system 100 includes a filter cartridge 200 and a filter head 300. The filter cartridge 200 (e.g., filter cartridge assembly, cartridge assembly, etc.) is removably coupled to the filter head 300 to allow for the filter cartridge 200 to be serviced or replaced. In some embodiments, the filter cartridge 200 is threadably coupled to the filter head 300. The filter cartridge 200 includes a filter element 202 and a shell housing 400. In some embodiments, the filter element 202 and the shell housing 400 are coupled together, for example by fasteners or adhesives, such that separation of the filter element 202 and the shell housing 400 cannot be separated without a physical destruction of one or more components. In some embodiments, the filter element 202 is removably coupled to the shell housing 400 such that the filter element 202 may be removed from the shell housing 400 and replaced with a new filter element. In some embodiments, the filter element 202 is rotatably coupled to the shell housing 400 such that the filter element 202 is rotatable relative to the shell housing 400 but is prevented from being axially separated from the shell housing 400, such as by latches, fingers, clips, fasteners, and the like.

The filter element 202 is disposed within a hollow portion 402 of the shell housing 400 such that a central axis 404 of the shell housing 400 extends through the filter element 202. The filter element 202 may be cylindrically-shaped and may include a cylindrically-shaped media pack 204. The media pack 204 includes filter media configured to filter particulate matter from a fluid flowing therethrough so as to produce filtered fluid (e.g., clean fluid). The filter media may include a porous material having a predetermined pore size. The filter media may include a paper-based filter media, a fiber-based filter media, a foam-based filter media, or the like. The filter media may be pleated or formed into another desired shape to increase a flow area through the media pack 204, or to otherwise alter the particle removal efficiency of the filter element 202. The filter element 202 may be arranged as an outside-in flow filter element having an outer dirty side and an inner clean side. In an alternative arrangement, the filter element 202 is an inside-out filter element having an inner dirty side and an outer clean side. Fluid to be filtered passes from the dirty side of the filter element 202 to the clean side of the filter element 202.

The filter element 202 defines a central opening 206 extending along a central axis 210 (e.g., a longitudinal axis, up and down as shown in FIG. 1) of the filter element 202. In some embodiments, the filter element 202 is positioned within the shell housing 400 such that the central axis 210 of the filter element 202 is coaxial (e.g., coincident) with the central axis 404 of the shell housing 400. A center support tube 208 is positioned within the media pack 204 and extends longitudinally along at least a portion of the central opening 206 from a first, upper end 212 of the filter element 202 to a second, bottom end 214 of the filter element 202. The media pack 204, and thus the support tube 208, is concentric with the filter element 202 and the shell housing 400. In other words, a central axis of the media pack 204 is coaxial or substantially coaxial with the central axis 210 of the filter element 202 as a whole and the central axis 404 of the shell housing 400. As shown in FIG. 1, the support tube 208 is formed in the shape of a hollow cylinder. An outer wall of the support tube 208 includes openings in order to allow fluid to pass through the support tube 208.

The shell housing 400 defines a hollow portion 402 having an inner cross-sectional diameter within which the filter element 202 is positioned. The shell housing 400 (e.g., a filter housing, container, or reservoir) includes a sidewall 408, an upper (e.g., first) shell end 412, and a lower (e.g., second) shell end 414. The sidewall 408 extends between the upper shell end 412 and the lower shell end 414 in a substantially concentric orientation relative to the central axis 404. The shell housing 400 may be formed from a strong and rigid material. For example, the shell housing 400 may be formed from a plastic material (e.g., polypropylene, high density polyethylene, polyvinyl chloride, nylon, etc.), a metal (e.g., aluminum, stainless steel, etc.), or another suitable material. The cross-sectional shape of the shell housing 400 may be the same or similar to the cross-sectional shape of the filter element 202. As shown in FIG. 1, the shell housing 400 is formed in the shape of a cylinder such that the shell housing 400 has a generally circular cross-section normal to the central axis 404 of the shell housing 400. In other embodiments, the shell housing 400 may have any other suitable cross-sectional shape; for example, racetrack/obround, oval, rounded rectangular, or another suitable shape.

As shown in FIG. 1, the shell housing 400 is threadably coupled to the filter head 300. The shell housing 400 includes a male threaded portion 410 disposed on the sidewall 408 of the shell housing 400 and extending downwardly (e.g., parallel to the central axis 404 of the shell housing 400) from the upper shell end 412 of the shell housing 400. The male threaded portion 410 is engaged with a female threaded portion 302 of the filter head 300. As shown in FIG. 1, the female threaded portion 302 is disposed on an inner surface 304 of an outer flange 306 of the filter head 300 such that, in an installed position (as shown in FIG. 1), the outer flange 306 at least partially surrounds the shell housing 400. The shell housing 400 and/or the filter head 300 may include one or more sealing mechanisms to prevent fluid from leaking into an environment surrounding the system 100. As shown in FIG. 1, the shell housing 400 includes an outer groove 416 configured to receive a radial sealing member 418 (e.g., an O-ring, gasket, etc.) that presses against the inner surface 304 of the outer flange 306 proximate to a lower edge (e.g., second end) 314 of the outer flange 306. The outer groove 416 is positioned proximate to the male threaded portion 410 at a position between the male threaded portion 410 and the lower shell end 414. The outer flange 306 includes an upper edge (e.g., first end) 312 that is opposite to the lower edge 314.

The filter element 202 is structured to detachably (e.g., removably) couple to the shell housing 400 and the filter head 300. The filter element 202 includes a first endcap 216 coupled to the first end 212 of the filter element 202 and a second endcap 218 coupled to the second end 214 of the filter element 202. The first endcap 216 and the second endcap 218 may be coupled to the media pack 204 using glue or another suitable bonding agent (e.g., adhesive product) in order to seal the first end 212 and the second end 214 of the media pack 204 and to prevent dirty fluid from bypassing the filter media through the first end 212 and the second end 214. In some embodiments, the first endcap 216 and the second endcap 218 are coupled to the media pack 204 without the use of adhesives. For example, a portion of the first endcap 216 may be heated to a molten state. The media pack 204 may then be plunged into the molten portion of the first endcap 216 to seal the media pack 204 to the first endcap 216. Similarly, a portion of the second endcap 218 may be heated to a molten state. The media pack 204 may then be plunged into the molten portion of the second endcap 218 to seal the media pack 204 to the second endcap 218. Coupling the first endcap 216 and the second endcap 218 in this way may reduce or eliminate the need for using adhesives, potting, or similar compounds to couple the media pack 204 to the first endcap 216 and the second endcap 218.

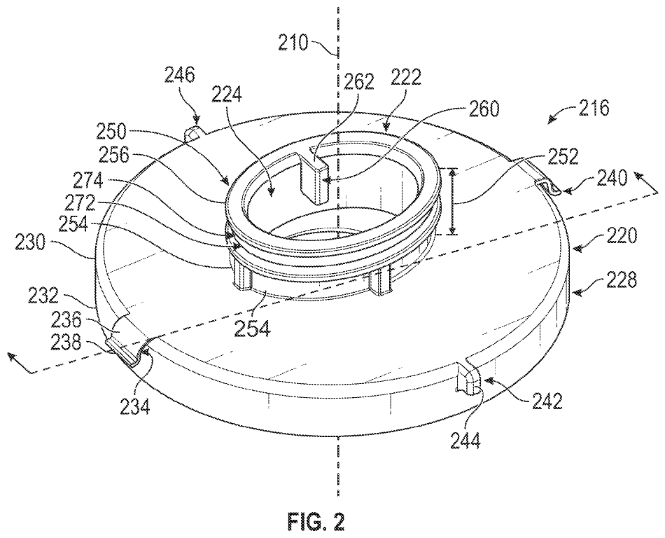

Turning now to FIG. 2, a perspective top view of the first endcap 216 is shown. The first endcap 216 includes an annular main body 220 and a center pipe 222. The main body 220 is centered on (e.g., substantially centered on) the central axis 210. The center pipe 222 extends axially away from the main body 220 in a direction away from the second endcap 218. Extending through both the main body 220 and the center pipe 222 is an endcap opening 224 that allows fluid communication between the filter head 300 and an internal cavity of the media pack 204. In some embodiments, the center pipe 222 is centered on the central axis 210. In some embodiments, the central axis 210 extends through the center pipe 222. In some embodiments, the center pipe 222 is off-center such that the center pipe 222, and therefore the endcap opening 224, are not intersected by the central axis 210.

The first endcap 216 further includes a first endcap flange 228 that extends axially from an outer perimeter of the main body 220. The first endcap flange 228 is coupled to the main body 220 at a first flange end 230 and terminates away from the main body 220 at a second flange end 232. The first endcap flange 228 extends away from the main body 220 in a direction opposite to the direction of the center pipe 222, and in a direction toward the second endcap 218. The first endcap 216 further includes an endcap latch 234 extending radially (e.g., substantially radially) away from the main body 220 proximate to the first flange end 230. The endcap latch 234 is structured for removably coupling the filter element 202 to the shell housing 400. In some embodiments, the endcap latch 234 couples the filter element 202 to the shell housing 400 such that the filter element 202 is allowed to rotate freely about the central axis 210 relative to the shell housing 400 while the filter element 202 is substantially prevented from moving axially along the central axis 210 relative to the shell housing 400 (e.g., being removed from the shell housing 400).

The endcap latch 234 includes a flexible finger 236 and a tooth 238. When the filter element 202 is installed within the shell housing 400, the flexible finger 236 flexes radially inward to a smaller diameter such that the tooth 238 engages a portion of the shell housing 400, such as a groove, to prevent axial movement of the filter element 202 relative to the shell housing 400 without substantial force (such as would be required when replacing the filter element 202). In some embodiments, as shown in FIG. 2, the endcap latch 234 is a first endcap latch 234, and the first endcap 216 further includes a second endcap latch 240 positioned circumferentially away from the first endcap latch 234 approximately 180 rotational degrees (e.g., 180°). The second endcap latch 240 is substantially similar to the first endcap latch 234. The first endcap latch 234 and the second endcap latch 240 cooperate to removably couple the filter element 202 to the shell housing 400. In some embodiments, the first endcap 216 can include more latches. For example, the first endcap 216 may include four first endcap latches 234 or four second endcap latches 240. The endcap latches 234, 240 can be spaced apart equidistantly around the first endcap 216.

In some embodiments, the first endcap 216 further includes a support projection 242. The support projection 242 extends radially away from the main body 220 proximate to the first flange end 230. The support projection 242 is configured to support the filter element 202 at a predetermined height within the shell housing 400 such that a distance between the first end 212 of the filter element 202 and the upper shell end 412 of the shell housing 400 is controlled to allow proper installation of the filter cartridge 200 with the filter head 300. The support projection 242 includes a support surface 244 that extends radially from the first endcap flange 228 between the first flange end 230 and the second flange end 232.

As outlined above, the position of the support surface 244 cooperates with a portion or surface of the shell housing 400 to control a relative position of the first end 212 of the filter element 202 and the upper shell end 412 of the shell housing 400 to allow proper installation of the filter cartridge 200 with the filter head 300. In some embodiments, and as shown in FIG. 2, the support projection 242 is a first support projection 242, and the first endcap 216 further includes a second support projection 246 that is positioned circumferentially away from the first support projection 242 approximately 180 rotational degrees (e.g., 180°). The second support projection 246 is substantially similar to the first support projection 242. The first support projection 242 and the second support projection 246 cooperate to support the filter element 202 within the shell housing 400.

The center pipe 222 of the first endcap 216 includes a pipe sidewall 250 that extends circumferentially about the endcap opening 224. The pipe sidewall 250 extends from the main body 220 by a first height 252, and the pipe sidewall 250 includes a first pipe end 254 and a second pipe end 256, the first pipe end 254 being coupled to the main body 220, and the second pipe end 256 being positioned away from the main body 220 opposite the first pipe end 254. The center pipe 222 further includes an alignment element, shown as alignment projection 260, that extends substantially radially inward from the pipe sidewall 250 and extends axially along the pipe sidewall 250 between the first pipe end 254 and the second pipe end 256.

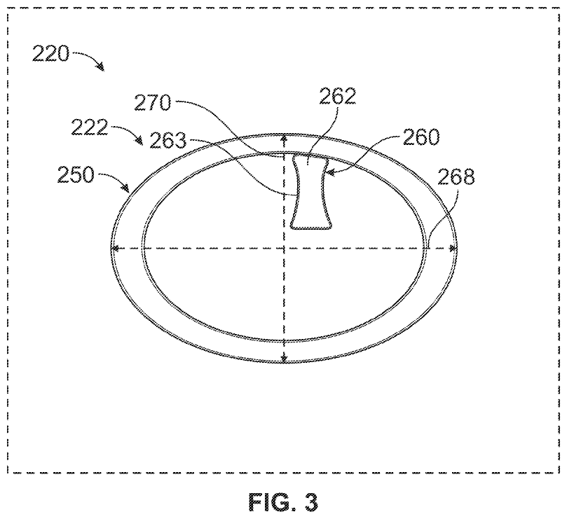

The alignment projection 260 includes a facing surface 262 that is contiguous with, and in the same plane as, the second pipe end 256. In some embodiments, the pipe sidewall 250 defines a substantially circular cross-section when viewed in the direction of the central axis 210. In some embodiments, as shown in FIGS. 2 and 3, the pipe sidewall 250, and therefore the center pipe 222, is ovular such that the center pipe 222 exhibits 180° rotational symmetry. In some embodiments, the center pipe 222 has a different cross-sectional shape that exhibits 180° rotational symmetry, such as a pill, obround, racetrack, ellipse, and the like. In some embodiments, the center pipe 222 has a cross-sectional shape that exhibits 360° rotational symmetry (e.g., no rotational symmetry), such as an egg shape.

Referring now to FIG. 3, a top-down view of the center pipe 222 is shown. The center pipe 222 includes a major axis 268 and a minor axis 270. The alignment projection 260 extends radially inward from the pipe sidewall 250 in a direction that is parallel (e.g., substantially parallel to) the minor axis 270. In some embodiments, the alignment projection 260 extends inward from the pipe sidewall 250 in a direction that is parallel to the major axis 268. In some embodiments, the alignment projection 260 extends inward in a radial direction. In some embodiments, the alignment projection 260 extends from the pipe sidewall 250 such that no portion of the alignment projection 260 intersects the major axis 268 or the minor axis 270. In some embodiments, the alignment projection 260 extends from the pipe sidewall 250 such that the alignment projection is intersected by the minor axis 270, but is not intersected by the major axis 268. In some embodiments, the alignment projection 260 is positioned such that both the major axis 268 and the minor axis 270 intersect the alignment projection 260. In some embodiments, the alignment projection 260 has a concave, or hourglass, profile that facilitates engagement between the alignment projection 260 and a portion of the filter head 300. The alignment projection 260 includes a projection engagement surface 263 that, in some embodiments, includes a concave profile to facilitate engagement between the alignment projection 260 and a portion of the filter head 300 (e.g., the alignment post 330). The projection engagement surface 263 extends axially along the alignment projection 260 and extends radially inward from the pipe sidewall 250.

Referring back to FIG. 2, the center pipe 222 further includes a pair of groove walls 272 that extend radially away from the outside of pipe sidewall 250 at a position between the first pipe end 254 and the second pipe end 256. The pair of groove walls 272 define a pipe groove 274 structured to receive a sealing member, such as an O-ring or a gasket.

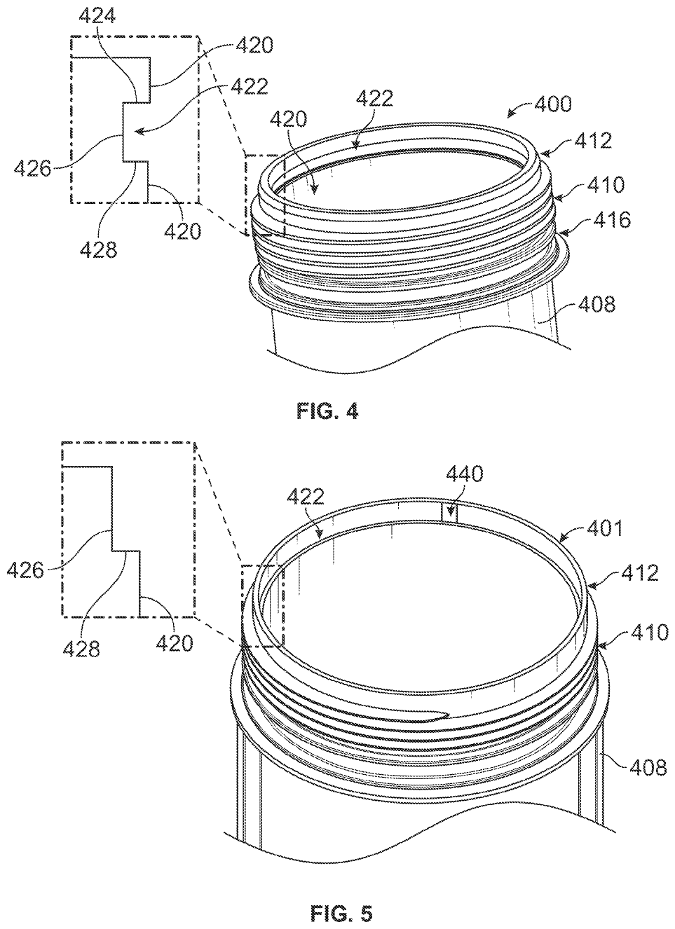

Referring now to FIG. 4, an upper portion of the shell housing 400 is shown with the filter element 202 removed. The shell housing 400 includes an inner shell surface 420 that extends between the upper shell end 412 and the lower shell end 414. Interrupting the inner shell surface 420 is an inner housing groove 422 that includes a first groove surface (e.g., top axial surface) 424, a second groove surface (e.g., recessed surface) 426, and a third groove surface (e.g., bottom axis surface, support surface) 428. The second groove surface 426 defines a diameter that is greater than a diameter of the inner shell surface 420. When the filter element 202 is coupled to the shell housing 400, the flexible finger 236 flexes radially outward such that the tooth 238 is disposed within the inner housing groove 422 and rests on the third groove surface 428. Engagement between the tooth 238 and the first groove surface 424 prevents (e.g., resists) the filter element 202 from being removed from the shell housing 400 unintentionally, such as during installation or during use. The second groove surface 426 is substantially smooth about the circumference of the second groove surface 426 such that the tooth 238 is able to transverse the circumference of the inner housing groove 422 without interruption. In other words, the inner housing groove 422 allows the filter element 202 to rotate freely about the central axis 210, 404 relative to the shell housing 400 while the inner housing groove 422 prevents accidental removal of the filter element 202 from the shell housing 400.

Referring now to FIG. 5, a perspective view of an upper portion of a shell housing 401 is shown without the filter element 202 installed, according to an example embodiment. The shell housing 401 of FIG. 5 is substantially similar to the shell housing 400 of FIG. 4. Accordingly, like numbering is used to denote like parts between the shell housing 400 of FIG. 4 and the shell housing 401 of FIG. 5. A difference between the shell housing 401 of FIG. 5 and the shell housing 400 of FIG. 4 is that that shell housing 401 of FIG. 5 does not include the first groove surface 424. In other words, the shell housing 401 does not include a portion of the inner shell surface 420 positioned between the outer groove 416 and the upper shell end 412. When the filter element 202 is positioned within the shell housing 401, the tooth 238 of the flexible finger 236 and the support surface 244 of the support projection 242 engage with and rest upon the third groove surface 428 of the shell housing 401 to control a relative position of the first end 212 of the filter element 202 and the upper shell end 412 of the shell housing 401 to allow proper installation of the filter cartridge 200 with the filter head 300. Accordingly, without the first groove surface 424, the filter element 202 is easier to remove from the shell housing 401. It can be appreciated by those of ordinary skill that it is not necessary for the filter element 202 to be coupled to the shell housing 401. Rather, the engagement between the first endcap 216 and the third groove surface 428 may be sufficient for proper installation of the filter cartridge 200 with the filter head 300.

In some embodiments, the shell housing 401 includes a detent 440 that interrupts the second groove surface 426. The detent 440 extends radially inward from the second groove surface 426 and toward the central axis 404. In some embodiments, the detent 440 extends radially into the housing sidewall 408 in a direction away from the central axis 404. The detent 440 is structured to interface with at least one of the flexible finger 236 and the support projection 242 to resist, but not prevent, rotation of the filter element 202 relative to the shell housing 401. For example, as the shell housing 401 is being threaded to the filter head 300, the filter element 202 may be held rotationally still relative to the filter head 300. As the shell housing 401 continues to rotate, the installer will feel a bump each time one of the flexible finger 236 or the support projection 242 passes by the detent 440, which provides haptic feedback to the installer about the progress of the filter element 202. The shell housing 400 of FIG. 4 may include the detent 440.

As outlined further herein, the filter head 300 is configured to engage with and prevent rotation of the filter element 202 as the filter cartridge 200 is being installed with the filter head 300. If, for example, the portion of the filter head 300 that prevents rotation of the filter element 202 is broken, then the installer would not feel the detent 440 as the shell housing 400 is threaded to the filter head 300. Therefore, the installer would feel haptic feedback (or lack thereof) indicating that something is wrong internally, or that one of the filter element 202, the filter head 300, or the shell housing 400 is the inappropriate component.

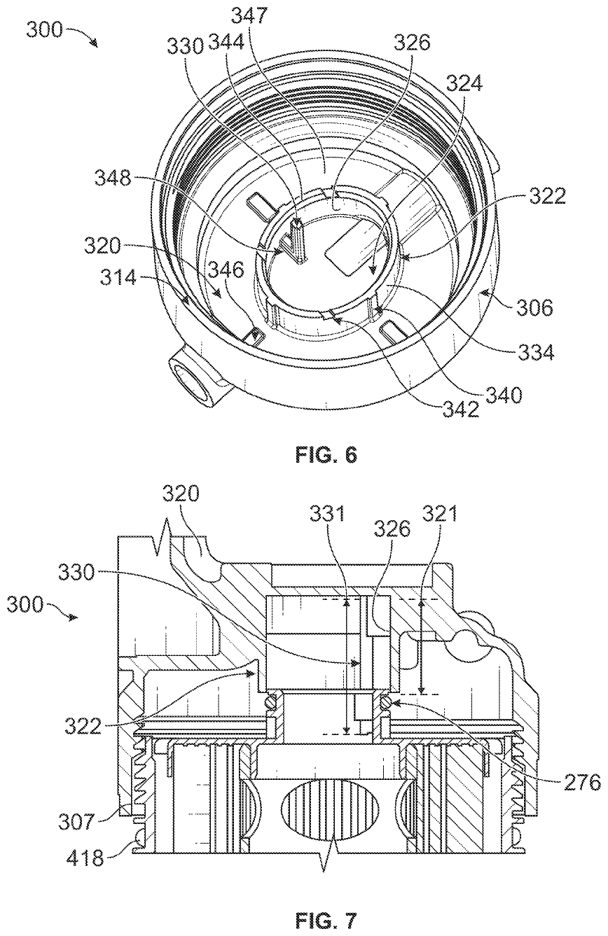

Turning now to FIGS. 6 and 7, the filter head 300 is shown. Referring specifically to FIG. 6, a bottom perspective view of the filter head 300 is shown, according to an example embodiment. The filter head 300 includes a main head body 320 and a center port 322 extending axially from the main head body 320 and extending is a direction similar to the outer flange 306 (e.g., in a direction toward the second endcap 218 when the filter cartridge 200 is attached to the filter head 300). The center port 322 includes a port opening 324 configured to receive the center pipe 222 of the first endcap 216. In other words, an inner circumference of the center port 322 is greater than an outer circumference of the center pipe 222. The center port 322 includes a substantially smooth inner port surface 326 that extends circumferentially about the interior of the center port 322. The inner port surface 326 is configured to cooperate with the pipe groove 274 and a pipe sealing member (e.g., O-ring or gasket) 276 positioned within the pipe groove 274 to form a sealing engagement between the filter head 300 and the filter element 202.

The inner port surface 326 defines a cross-sectional shape that is similar (e.g., substantially similar) to the cross-sectional shape of the center pipe 222 of the first endcap 216. In some embodiments, the inner port surface 326 defines a substantially circular cross-section when viewed in the direction of the central axis 404. In some embodiments, as shown in FIG. 6, the inner port surface 326, and therefore the center port 322, is ovular such that the center port 322 exhibits 180° rotational symmetry. In some embodiments, the center port 322 has a different cross-sectional shape that exhibits 180° rotational symmetry, such as a pill, obround, racetrack, ellipse, and the like. In some embodiments, the center port 322 has a cross-sectional shape that exhibits 360° rotational symmetry (e.g., no rotational symmetry), such as an egg shape. The port opening 324 is in fluid communication with an inlet/outlet port of the filter head 300.

The main head body 320 further includes an alignment post 330 positioned within the center port 322 and extending substantially parallel to the central axis 404. The alignment post 330 extends axially from the main head body 320 in a direction similar to the center port 322 (e.g., in a direction toward the second endcap 218 when the filter cartridge 200 is coupled to the filter head 300). The relationship between the alignment post 330 and the center port 322 is substantially similar to the relationship between the alignment projection 260 and the center pipe 222. Specifically, in embodiments where the center port 322 defines an ovular cross-sectional shape, the alignment post 330 may extend from the main head body 320 such that no portion of the alignment post 330 intersects the major axis or the minor axis of the inner port surface 326. In some embodiments, the alignment post 330 is positioned such that the alignment post 330 is intersected by the minor axis of the inner port surface 326, but is not intersected by the major axis of the inner port surface 326. In some embodiments, the alignment post 330 is positioned such that both the major axis and the minor axis of the inner port surface 326 intersect the alignment post 330. The alignment post 330 may have a wide variety of cross-sectional shapes such as plus-shaped (as shown in FIG. 6), circular (as shown in FIG. 7), and the like.

Referring now to FIG. 7, a side cross-sectional view of the filter head 300 is shown, according to an example embodiment. The alignment post 330 extends from the main head body 320 by a post height (e.g., axial height, axial post height, axial post length, etc.) 331. The post height 331 is greater than the height of the center port 322, shown as a port height (e.g., axial height, axial port height, etc.) 321. The alignment post 330 extends further than the inner port surface 326 such that, during installation of the filter cartridge 200 with the filter head 300, the alignment post 330 engages the first endcap 216 of the filter element 202 before any portion of the center pipe 222 is disposed within the center port 322 (e.g., the port opening 324). As the filter cartridge 200 is threaded to the filter head 300, the alignment post 330 engages the alignment projection 260, which prevents further rotation of the filter element 202 in the “tightening” direction. When the alignment post 330 is engaged with the alignment projection 260, the center pipe 222 and the center port 322 are aligned such that the cross-sectional shapes match. As the shell housing 400 continues to be threaded to the filter head 300, the filter element 202 spins freely within the shell housing 400 and the filter element 202 moves axially along the central axis 404 while being rotationally still (e.g., not rotating about the central axis 404) relative to the filter head 300. When the filter cartridge 200 is fully installed, the pipe sealing member 276 engages with, and forms a sealing engagement with, the inner port surface 326, and the radial sealing member 418 engages with, and forms a sealing engagement with, a sealing surface 307 of the outer flange 306.

The alignment post 330 and the alignment projection 260 of the system 100 provide the advantage of permitting the easier implementation and use of a non-circular center pipe (e.g., the center pipe 222) and a non-circular center port (e.g., the center port 322) within a filtration system that includes a threaded filter cartridge, such as the threaded filter cartridge 200. Without the alignment post 330 and the alignment projection 260, it would be more challenging to accurately thread the filter cartridge 200 to the filter head 300 such that the non-circular profiles of the center pipe 222 and the center port 322 align. One advantage of providing non-circular center pipes and center ports is to reduce the cost of manufacturing, since the center pipe 222 and the center port 322 do not have to be exactly circular.

Another advantage of providing a non-circular center pipe 222 and center port 322 is to reduce the instances of unauthorized replacement parts from being installed within the system 100. Referring again to FIG. 6, the center port 322 includes an interference projection 340 extending radially away from an outer surface 334 of the center port 322. The interference projection 340 is configured to prevent a radial seal from being formed about the outer surface 334 of the center port 322. The interference projection 340 extends axially along the entire length of the port height 321. In some embodiments, the interference projection 340 is a first interference projection 340, and the center port 322 includes a plurality of interference projections positioned circumferentially about the outer surface 334.

The center port 322 further includes an interference indent 342 extending axially into a facing surface 344 of the center port 322. The interference indent 342 is configured to prevent an axial sealing engagement from being formed with the facing surface 344. In some embodiments, the interference indent 342 is a first interference indent 342 and the center port 322 includes a plurality of interference indents positioned circumferentially about facing surface 344. The main head body 320 further includes an interference tab 346 extending axially from the main head body 320 in the same direction as the center port 322 (e.g., toward the second endcap 218 when the filter cartridge 200 is coupled to the filter head 300). The interference tab 346 is configured to prevent an axial sealing engagement from being formed with the main body facing surface 347. In some embodiments, the interference tab 346 is a first interference tab 346 and the main head body 320 includes a plurality of interference tabs positioned circumferentially about main body facing surface 347.

The filter head 300 further includes a stop fixture 348 extending axially from the main head body 320 at a position radially within the inner port surface 326. The stop fixture 348 extends axially in a direction similar to the alignment post 330. In some embodiments, the stop fixture 348 is structured to engage the center pipe 222 of the first endcap 216 to stop further threading of the filter cartridge 200 to the filter head 300.

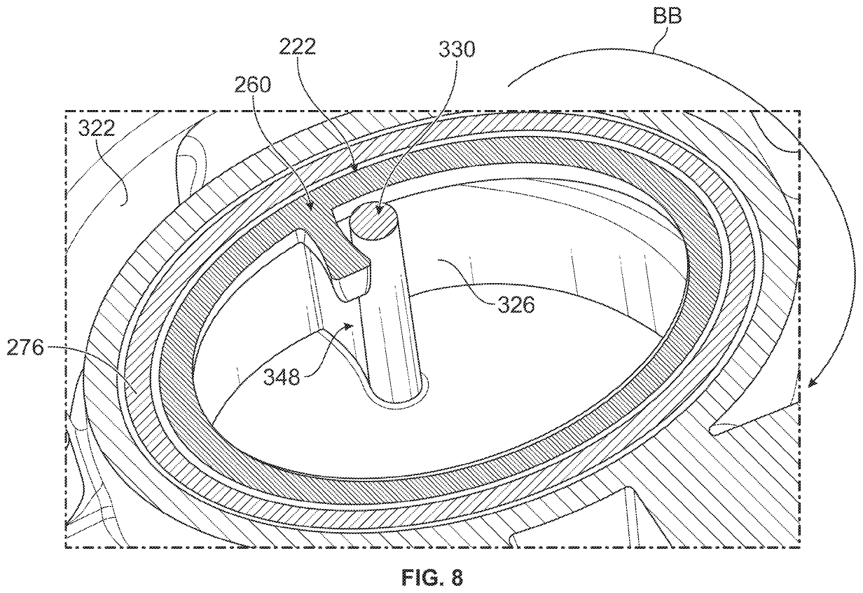

Referring now to FIG. 8, a detailed cross-sectional view of the center pipe 222 positioned within the center port 322 is shown at the line AA of FIG. 1. For reference, the “tightening” direction is shown by arrow BB. The first endcap 216 is structured such that when the alignment projection 260 is engaging the alignment post 330, the center pipe 222 is aligned with the center port 322 and rotation of the filter element 202 relative to the filter head 300 in the “tightening” direction is substantially prevented. The pipe sealing member 276 cooperates with the inner port surface 326 to form a sealing engagement between the filter element 202 and the filter head 300.

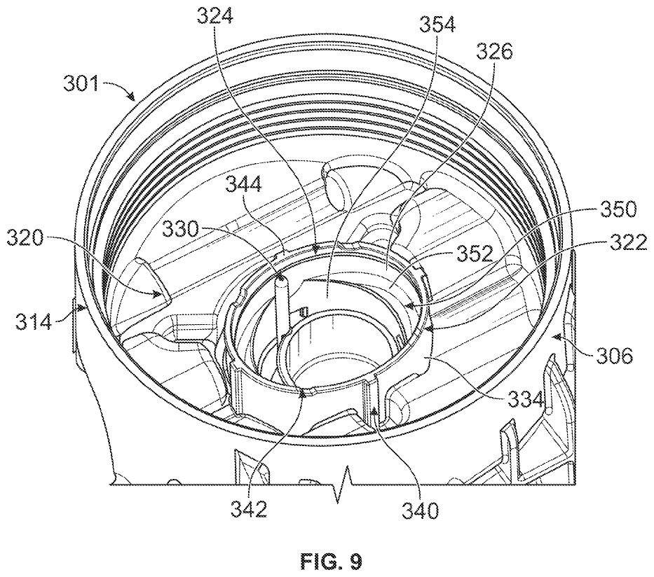

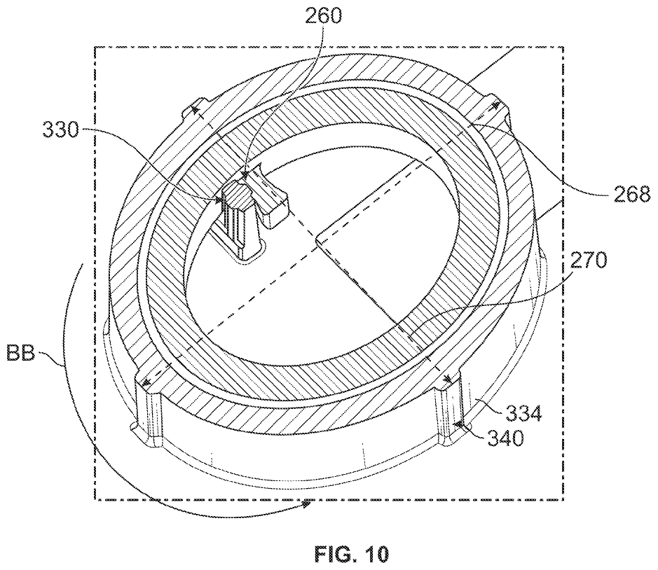

Referring now to FIGS. 9 and 10, a filter head 301 is shown, according to an example embodiment. The filter head 301 of FIG. 9 is similar to the filter head 300 of FIG. 6. Accordingly, like numbering is used to denote like parts. FIG. 9 shows a bottom perspective view of the filter head 301. The filter head 301 includes a main head body 320 and a center port 322 extending axially from the main head body 320 and extending is a direction similar to the outer flange 306 (e.g., in a direction toward the second endcap 218 when the filter cartridge 200 is attached to the filter head 301). The center port 322 includes a port opening 324 configured to receive the center pipe 222 of the first endcap 216. The center port 322 includes a first inner port surface 326 that extends circumferentially about the interior of the center port 322. The first inner port surface 326 is configured to cooperate with the pipe groove 274 and the pipe sealing member 276 positioned within the pipe groove 274 to form a sealing engagement between the filter head 301 and the filter element 202.

The first inner port surface 326 defines a cross-sectional shape that is similar (e.g., substantially similar) to the cross-sectional shape of the center pipe 222 of the first endcap 216. In some embodiments, the first inner port surface 326 defines a substantially circular cross-section when viewed in the direction of the central axis 404. In some embodiments, as shown in FIG. 9, the first inner port surface 326, and therefore the center port 322, is ovular such that the center port 322 exhibits 180° rotational symmetry. In some embodiments, the center port 322 has a different cross-sectional shape that exhibits 180° rotational symmetry, such as a pill, obround, racetrack, ellipse, and the like. In some embodiments, the center port 322 has a cross-sectional shape that exhibits 360° rotational symmetry (e.g., no rotational symmetry), such as an egg shape. The port opening 324 is in fluid communication with a first port of the filter head 301.

The center port 322 further includes a flange (e.g., skirt, shelf, etc.) 350 extending radially inward from the first inner port surface 326. The flange 350 includes a flange facing surface 352 that is contiguous with the first inner port surface 326. The flange facing surface 352 has a crescent shape that extends circumferentially within the center port 322. The flange 350 further includes a second inner port surface that extends circumferentially about the central axis 404 and is positioned radially within the first inner port surface 326. The second inner port surface 354 defines a profile that is different from the profile of the first inner port surface 326. For example, in embodiments where the first inner port surface 326 is elliptical, the second inner port surface 354 may be circular. The flange 350 is configured to provide a secondary assurance against the use of unauthorized filter elements. Specifically, the center port 322 having the flange 350 is structured to receive a multi-step center pipe from a filter element, where the tip of the center pipe has a smaller diameter (e.g., major diameter, minor diameter) than the mid-section of the center pipe 222. The second inner port surface 354 is configured to cooperate with a sealing member coupled to a stepped center pipe to form a sealing engagement between the second inner port surface 354 and the filter element having the stepped center pipe.

The main head body 320 further includes an alignment post 330 positioned within the center port 322 and extending substantially parallel to the central axis 404. The alignment post 330 extends axially from the main head body 320 in a direction similar to the center port 322 (e.g., in a direction toward the second endcap 218 when the filter cartridge 200 is coupled to the filter head 300). The relationship between the alignment post and the center port 322 is substantially similar to the relationship between the alignment projection 260 and the center pipe 222. Specifically, in embodiments where the center port 322 defines an ovular cross-sectional shape, the alignment post 330 may extend from the main head body 320 such that no portion of the alignment post 330 intersects the major axis or the minor axis of the inner port surface 326. In some embodiments, the alignment post 330 is positioned such that the alignment post 330 is intersected by the minor axis of the inner port surface 326, but is not intersected by the major axis of the inner port surface 326. In some embodiments, the alignment post 330 is positioned such that both the major axis and the minor axis of the inner port surface 326 intersects the alignment post 330. The alignment post 330 may have most any cross-sectional shape such as plus-shaped, circular, and the like.

The center port 322 further includes an interference projection 340 extending radially away from an outer surface 334 of the center port 322. The interference projection 340 is configured to prevent a radial seal from being formed about the outer surface 334 of the center port 322. The interference projection 340 extends axially along the entire length of the port height 321. In some embodiments, the interference projection 340 is a first interference projection 340, and the center port 322 includes a plurality of interference projections positioned circumferentially about the outer surface 334. The center port 322 further includes an interference indent 342 extending axially into a facing surface 344 of the center port 322. The interference indent 342 is configured to prevent an axial sealing engagement from being formed with the facing surface 344. In some embodiments, the interference indent 342 is a first interference indent 342 and the center port 322 includes a plurality of interference indents positioned circumferentially about facing surface 344.

Referring now to FIG. 10, a detailed cross-sectional view of the center pipe 222 positioned within the center port 322 is shown at the line AA of FIG. 1, according to an example embodiment. The filter head 301 shown in FIGS. 9 and 10 is reverse threaded. Accordingly, the “tightening” direction is shown by arrow BB. The first endcap 216 is structured such that when the alignment projection 260 is engaging the alignment post 330, the center pipe 222 is aligned with the center port 322 and rotation of the filter element 202 relative to the filter head 301 in the “tightening” direction is substantially prevented. The pipe sealing member 276 cooperates with the inner port surface 326 to form a sealing engagement between the filter element 202 and the filter head 301. The alignment post 330 is positioned such that neither of the major axis nor the minor axis of the center port 322 (similar to the major axis 268 and the minor axis 270 of the center pipe 222) intersects the alignment post 330 when the center pipe 222 is received within the center port 322 and the alignment projection 260 abuts the alignment post 330.

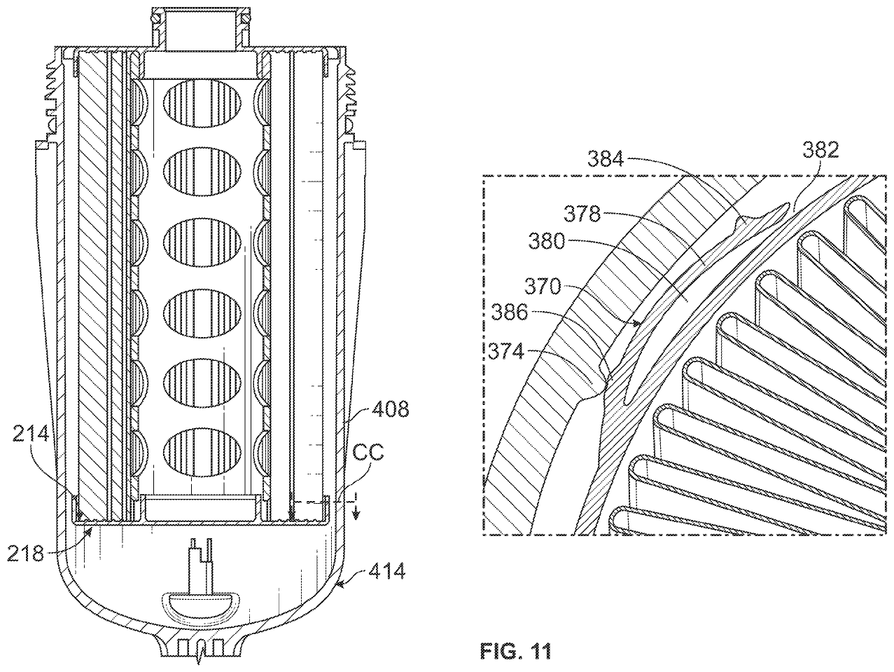

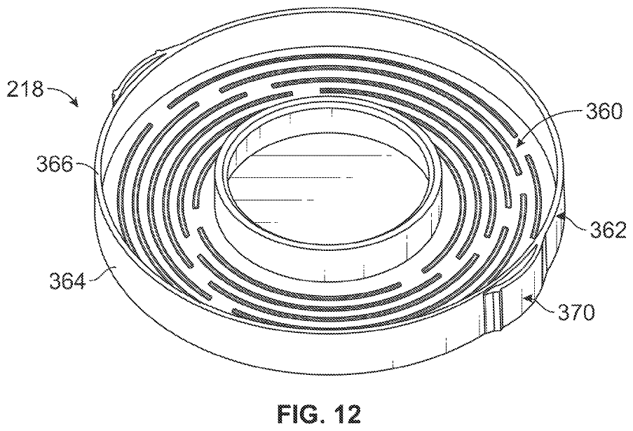

Referring now to FIG. 11, a cross-sectional view of the filter cartridge 200 is shown with a detailed cross-sectional view of a portion of the lower shell end 414 of the shell housing 400 taken at line CC. Referring also to FIG. 12, a perspective view of the second endcap 218 is shown. The second endcap 218 includes a main endcap body 360 having an endcap flange 362 that extends axially from a perimeter of the main endcap body 360 in a direction toward the first endcap 216. The endcap flange 362 includes a first flange end 364 coupled to the main endcap body 360 and a second flange end 366 positioned opposite the first flange end 364. The endcap flange 362 is substantially concentric about the central axis 210. The second endcap 218 further includes a retainer element 370 (e.g., retainer clip, projection, spring clip, etc.). The retainer element 370 is coupled to and extends radially from the endcap flange 362 in a direction away from the central axis 210. The retainer element 370 is structured to engage a portion of the shell housing 400 when the filter element 202 is positioned within the shell housing 400. The retainer element 370 is configured to engage a retainer projection 374 (FIG. 11) of the shell housing 400. The retainer element 370 and the retainer projection 374 cooperate, in some embodiments, to prevent rotation of the filter element 202 relative to the shell housing 400 about the central axis 404.

The retainer element 370 includes a lever arm 378 that defines a crescent shape. The lever arm 378 extends away from the endcap flange 362 in a direction away from the central axis 210 and then wraps back toward the endcap flange 362, forming a compression cavity 380 between the lever arm 378 and the endcap flange 362. The lever arm 378 is flexible such that when the second endcap 218 is positioned within the shell housing 400, the lever arm 378 is biased by the shell housing 400 toward the central axis 210 and into the compression cavity 380. The lever arm 378 includes a first orientation projection 384 and a second orientation projection 386, the first orientation projection 384 and the second orientation projection 386 configured to engage the retainer projection 374 to prevent rotation of the filter element 202 about the central axis 210 relative to the shell housing 400.

In some embodiments, an end of the lever arm 378 is slightly separated from the endcap flange 362 at a gap 382. The gap 382 may increase the compliance of the retainer element 370 such that less force is needed to compress the lever arm 378 into the compression cavity 380 and in a direction toward the central axis 210. In some embodiments, the retainer element 370 and the retainer projection 374 cooperate to resist, but not prevent, rotation of the filter element 202 relative to the shell housing 400. For example, as the shell housing 400 is being threaded to the filter head 300 (such as by reverse threading), the filter element 202 may be held rotationally still relative to the filter head 300. As the shell housing 400 continues to rotate, the installer will feel a bump each time the retainer element 370 of the second endcap 218 passes by and/or engages with the retainer projection 374, which provides haptic feedback to the installer about the progress of the filter element 202. If, for example, the portion of the filter head 300 that prevents rotation of the filter element 202 is broken, then the installer would not feel the bump caused by the interference between the retainer element 370 and the retainer projection 374 as the shell housing 400 is threaded to the filter head 300. Therefore, the installer would feel haptic feedback (or lack thereof) indicating that something is wrong internally, or that one of the filter element 202, the filter head 300, or the shell housing 400 is the inappropriate component.

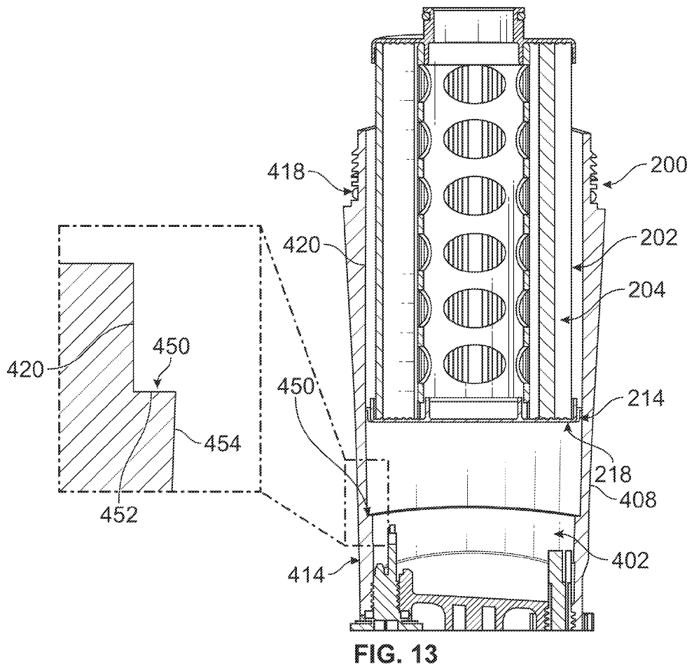

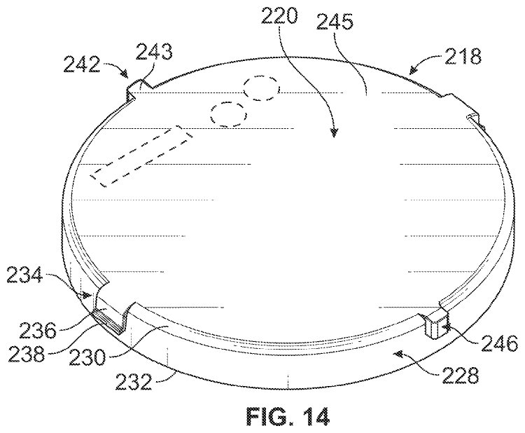

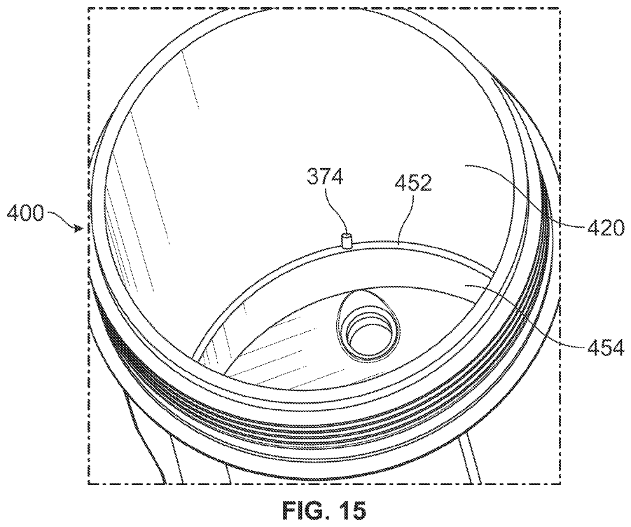

Referring now to FIG. 13, a cross-sectional view of the filter cartridge 200 is shown with the filter element 202 partially positioned within the shell housing 400. The shell housing 400 includes the inner shell surface 420 that extends between the upper shell end 412 and the lower shell end 414. Interrupting the inner shell surface 420 proximate to the lower shell end 414 is a housing flange 450 that includes a first flange surface (e.g., facing surface, top axial surface, etc.) 452 and a second flange surface (e.g., radial surface, second surface, etc.) 454. Both the first flange surface 452 and the second flange surface 454 have a diameter less than the inner shell surface 420. The first flange surface 452 extends radially inward from the inner shell surface 420 proximate to the lower shell end 414 and forms a step configured to engage with and axially limit insertion of the filter element 202. Turning to FIG. 14, the second endcap 218 is shown, according to an example embodiment. The second endcap 218 is similar to the first endcap 216 shown in FIG. 2. Accordingly, like numbering is used to denote like parts. A difference between the first endcap 216 shown in FIG. 2 and the second endcap 218 of FIG. 14 is that the second endcap 218 does not include the center pipe 222 or the endcap opening 224.

The second endcap 218 includes an annular main body 220 and a first endcap flange 228 that extends axially from an outer perimeter of the main body 220. The first endcap flange 228 is coupled to the main body 220 at a first flange end 230 and terminates away from the main body 220 at a second flange end 232. The first endcap flange 228 extends away from the main body 220 in a direction opposite toward the first endcap 216. The second endcap 218 further includes an endcap latch 234 extending radially (e.g., substantially radially) away from the main body 220 proximate to the first flange end 230. The endcap latch 234 is structured for removably coupling the filter element 202 to the shell housing 400. In some embodiments, the endcap latch 234 couples the filter element 202 to the shell housing 400 such that the filter element 202 is allowed to rotate freely about the central axis 210 relative to the shell housing 400 while the filter element 202 is substantially prevented from moving axially along the central axis 210 relative to the central axis 210 (e.g., being removed from the shell housing 400).

The endcap latch 234 includes a flexible finger 236 and a tooth 238. When the filter element 202 is installed within the shell housing 400, the flexible finger 236 flexes radially inward to a smaller diameter such that the tooth 238 engages a portion of the shell housing 400 to prevent axial movement of the filter element 202 relative to the shell housing 400 without substantial force (such as would be required when replacing the filter element 202). In some embodiments, as shown in FIG. 14, the endcap latch 234 is a first endcap latch 234, and the first endcap 216 further includes a second endcap latch 240 positioned circumferentially away from the first endcap latch 234 approximately 180 rotational degrees (e.g., 180°). The second endcap latch 240 is substantially similar to the first endcap latch 234. The first endcap latch 234 and the second endcap latch 240 cooperate to removably coupled the filter element 202 to the shell housing 400.

In some embodiments, the first endcap 216 further includes a support projection 242. The support projection 242 extends radially away from the main body 220 proximate to the first flange end 230. The support projection 242 is configured to support the filter element 202 at a predetermined height within the shell housing 400 such that a distance between the first end 212 of the filter element 202 and the upper shell end 412 of the shell housing 400 is controlled to allow proper installation of the filter cartridge 200 with the filter head 300.

The support projection 242 includes a support surface 243 that extends radially from the first endcap flange 228 and is contiguous with a facing surface 245 of the main body 220. The support surface 243 cooperates with the first flange surface 452 of the shell housing 400 to control a relative position of the first end 212 of the filter element 202 and the upper shell end 412 of the shell housing 400 to allow proper installation of the filter cartridge 200 with the filter head 300. In some embodiments, as shown in FIG. 14, the support projection 242 is a first support projection 242, and the second endcap 218 further includes a second support projection 246 that is positioned circumferentially away from the first support projection 242 approximately 180 rotational degrees (e.g., 180°). The second support projection 246 is substantially similar to the first support projection 242. The first support projection 242 and the second support projection 246 cooperate to support the filter element 202 within the shell housing 400.

Referring now to FIG. 15, a perspective top view of the shell housing 400 is shown with the filter element 202 removed. The shell housing 400 includes the retainer projection 374 extending from the inner shell surface 420 proximate to the first flange surface 452. In some embodiments, as shown in FIG. 15, the shell housing 400 does not include the inner housing groove 422.

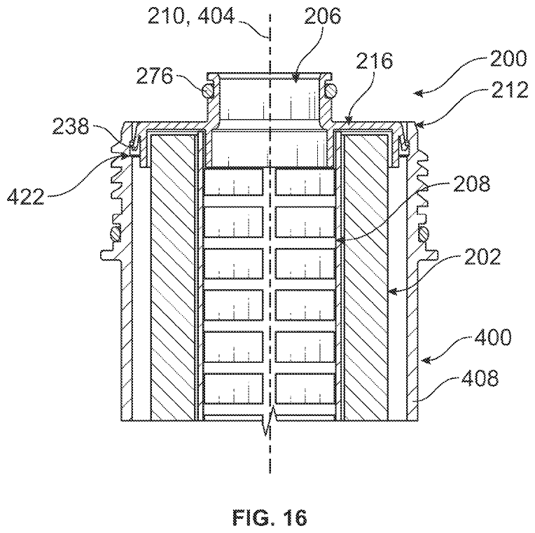

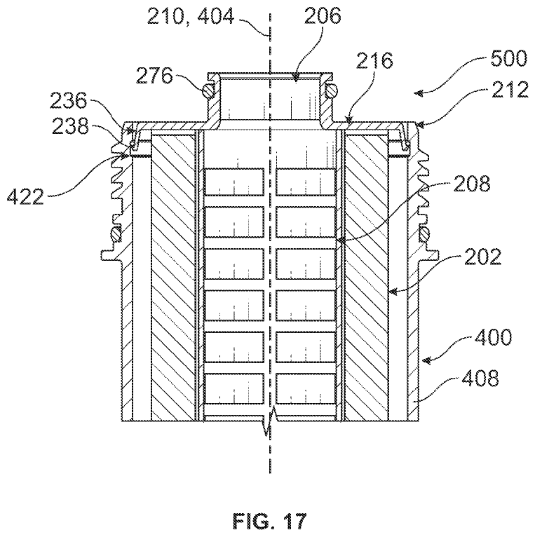

Referring now to FIG. 16, a side, cross-sectional view of the filter cartridge 200 is shown with the filter element 202 having the first endcap 216 shown in FIGS. 2 and 3. The tooth 238 is positioned within the outer groove 416. Referring now to FIG. 17, a cross-sectional view of the filter cartridge 200 is shown with the filter element 202 includes an alternative first endcap, shown as a first endcap 500. The first endcap 500 is similar to the first endcap 216. Accordingly, like numbering is used to denote like parts. A difference between the first endcap 500 and the first endcap 216 is that the first endcap 500 does not include the first endcap flange 228. The flexible finger 236 extends from the perimeter of the main body 220 and extends away from the main body 220 in a direction that is both radially outward and axially toward the second endcap 218 (e.g., in a direction opposite to the direction of extension of the center pipe 222).

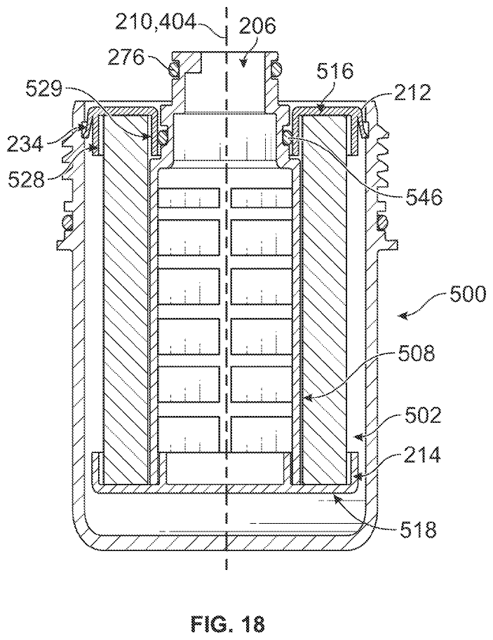

Referring now to FIG. 18, the filter cartridge 200 is shown with an alternative filter element, shown as a filter element 502. The filter element 502 is similar to the filter element 202 shown in FIG. 1. Accordingly, like numbering is used to denote like parts between the filter element 202 of FIG. 1 and the filter element 502. A difference between the filter element 202 and the filter element 502 is that the center pipe 222 of the filter element 502 is coupled to (e.g., integrally formed with) the support tube 208. As utilized herein, two or more elements are “integrally formed” with each when the two or more elements are formed and joined together as part of a single manufacturing process to create a single-piece or unitary construction that cannot be disassembled without an at least partial destruction of the overall component.

The filter element 502 is disposed within a hollow portion 402 of the shell housing 400 such that a central axis 404 of the shell housing 400 extends through the filter element 502. The filter element 502 may be cylindrically-shaped and may include the media pack 204. The filter element 502 may be arranged as an outside-in flow filter element having an outer dirty side and an inner clean side. In an alternative arrangement, the filter element 502 is an inside-out filter element having an inner dirty side and an outer clean side. Fluid to be filtered passes from the dirty side of the filter element 502 to the clean side of the filter element 502.

The filter element 502 defines the central opening 206 extending along the central axis 210 (e.g., a longitudinal axis, up and down as shown in FIG. 18) of the filter element 502. The filter element 502 includes a center support tube 508 that is positioned within the media pack 204 and extends longitudinally between the first, upper end 212 of the filter element 502 to the second, bottom end 214 of the filter element 502. The media pack 204, and thus the support tube 508, is concentric with the filter element 502 and the shell housing 400. In other words, a central axis of the media pack 204 is coaxial or substantially coaxial with the central axis 210 of the filter element 502 as a whole and the central axis 404 of the shell housing 400. As shown in FIG. 18, the support tube 508 is formed in the shape of a hollow cylinder. An outer wall of the support tube 508 is perforated in order to allow fluid to pass through the support tube 508.

The filter element 502 is structured to detachably (e.g., removably) couple to the shell housing 400 and the filter head 300. The filter element 502 includes a first endcap 516 coupled to the first end 212 of the filter element 502 and a second endcap 518 coupled to the second end 214 of the filter element 502. The first endcap 516 and the second endcap 518 may be coupled to the media pack 204 using any of the methods outlined above with respect to the filter element 202. The first endcap 516 is similar to the first endcap 216 shown in FIG. 2. Accordingly, like numbering is used to denote like parts between the first endcap 216 and the first endcap 516. A difference between the first endcap 216 and the first endcap 516 is that the first endcap 516 does not include the center pipe 222, but does include a central opening (similar to the endcap opening 224).

The first endcap 516 includes an annular main body 520 centered on (e.g., substantially centered on) the central axis 210, an endcap opening 524 extending through the main body 520, a first endcap flange 528, and a second endcap flange 529. The first endcap flange 528 extends axially from an outer perimeter of the main body 520 in a direction toward the second endcap 518. The first endcap flange 528 is coupled to the main body 520 at a first flange end 530 and terminates away from the main body 520 at a second flange end 532. The first endcap 516 further includes a second endcap flange 529 extending axially from an inner perimeter of the main body 520 in a similar direction as the first endcap flange 528 (e.g., in a direction toward the second endcap 518). The second endcap flange 529 includes an annular inner endcap surface 531 configured to form a radial sealing engagement with the support tube 508. The second endcap flange 529 and the inner endcap surface 531 define the endcap opening 524. The endcap opening 524 is configured to receive at least a portion of the support tube 508.

The first endcap 516 further includes the endcap latch 234, similar to the endcap latch 234 of the first endcap 216 of FIG. 2. In some embodiments, the first endcap 516 includes the support projection 242, similar to the support projection 242 of the first endcap 216 of FIG. 2.

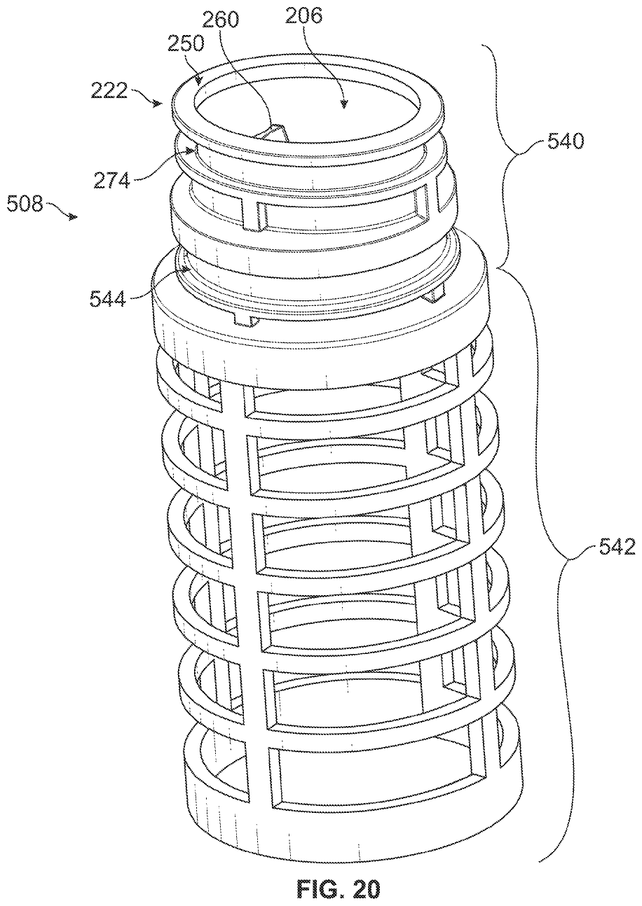

Referring now to FIG. 20, a perspective view of the support tube 508 is shown. The support tube 508 includes a first tube portion 540 and a second tube portion 542 coupled to the first tube portion 540. Both the first tube portion 540 and the second tube portion 542 are centered on the central axis 210 when the support tube 508 is coupled to the filter element 502. The first tube portion 540 is configured to extend through the endcap opening 524 of the first endcap 516 and the first tube portion 540 is configured to form a radial sealing engagement with the inner endcap surface 531 of the second endcap flange 529. The first tube portion 540 includes a portion groove 544 that extends circumferentially about the first tube portion 540 and is configured to receive a first portion sealing member 546 (FIG. 18). In some embodiments, the portion groove 544 is circular and the inner endcap surface 531 is circular such that the first endcap 516 is able to rotate about the central axis 210 relative to the support tube 508.

The first tube portion 540 further includes the center pipe 222, which is substantially similar to the center pipe 222 of the first endcap 216 of FIG. 2. The center pipe 222 includes a pipe sidewall 250, which extends circumferentially about the central opening 206. The pipe sidewall 250 includes the first pipe end 254 and the second pipe end 256, the first pipe end 254 being positioned proximate to the portion groove 544 such that the portion groove 544 is positioned between the center pipe 222 and the second tube portion 542. The second tube portion 542 is substantially similar to the support tube 208 shown in FIGS. 1, 16, and 17.

The pipe groove 274 extends circumferentially about the first tube portion 540 and is configured to form a radial sealing engagement with the filter head 300. In some embodiments, the center pipe 222 defines an elliptical profile that matches an elliptical profile of the center port 322 of the filter head 300. In some embodiments, a profile of the center pipe 222 may be different from a profile of the portion groove 544. For example, the center pipe 222, and thus the pipe groove 274, may be elliptical, and the portion groove 544 may be circular.

When the filter cartridge 200 with the filter element 502 is threaded to the filter head 300, the alignment projection 260 of the center pipe 222 of the support tube 508 engages with the alignment post 330 of the filter head 300 to prevent rotation of the support tube 508 about the central axis 404 relative to the filter cartridge 200 in the “tightening” direction. In some embodiments, as outlined above with respect to FIGS. 5, 11, and 12, various feature of the shell housing 400 (e.g., 374, 440) may resist or prevent rotation of the first endcap 216, 516 and the second endcap 218, 518 relative to the shell housing 400. Accordingly, during threading of the filter cartridge 200 to the filter head 300, the support tube 508 may rotate about the central axis 210, 404 independently of the first endcap 216, 516 and the second endcap 218, 518 such that filter cartridge 200 may include features that prevent the media pack 204 and the endcaps (216, 218, 516, 518) from rotating relative to the shell housing 400 while the filter cartridge 200 is being threaded to the filter head 300.

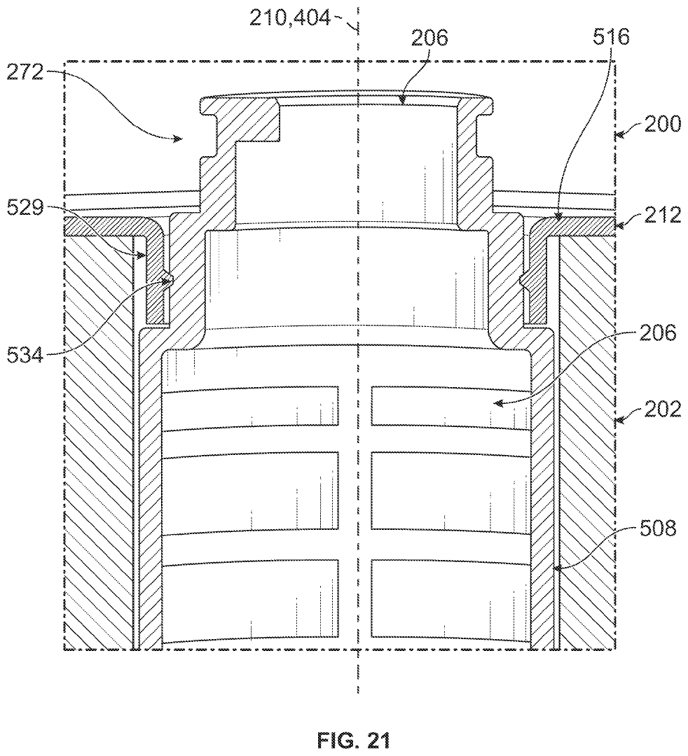

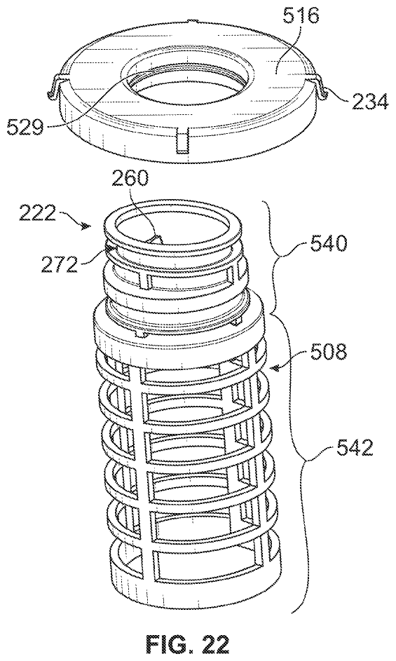

Referring now to FIGS. 21 and 22, the support tube 508 is shown, according to an example embodiment. As shown, the support tube 508 may be fixedly coupled (e.g., permanently coupled, etc.) to the first endcap 516, such as by a spin weld 534. Specifically, the first tube portion 540 is coupled to the second endcap flange 529 of the first endcap 516. The spin weld 534 replaces the portion groove 544 of the support tube of FIGS. 18 and 20.

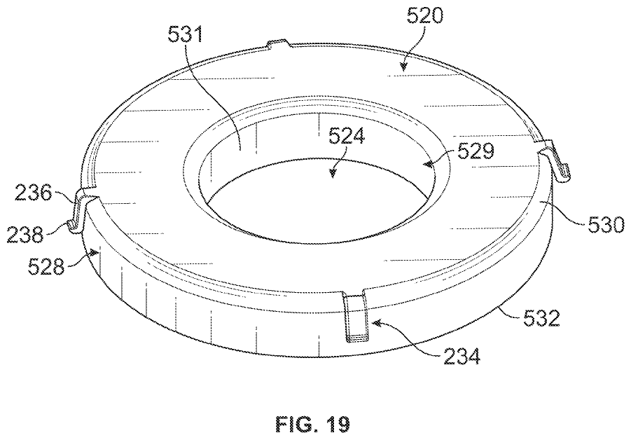

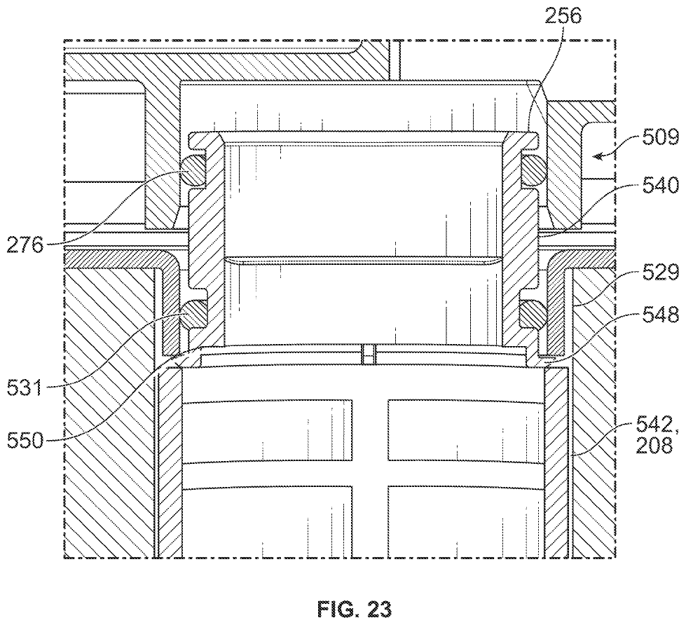

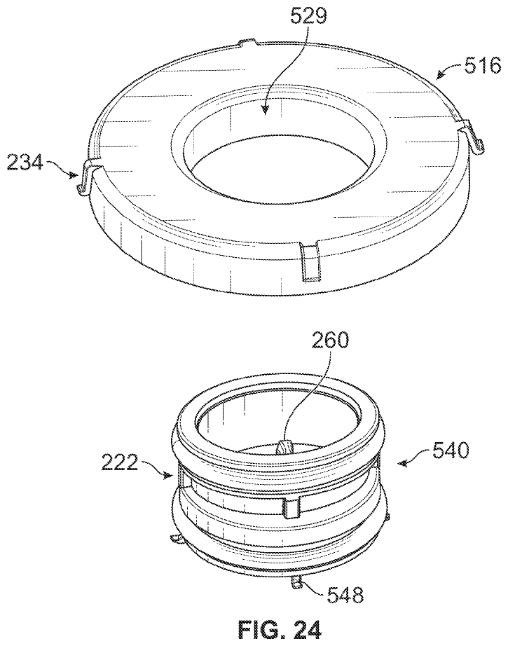

Referring now to FIGS. 23 and 24, an alternative support tube 509 is shown according to an example embodiment. A difference between the support tube of FIGS. 23 and 24 and the support tube of FIGS. 18-22 is that the first tube portion 540 is separable from the support tube 509. This may be advantageous in filtration systems where the center port 322 of the filter head 300 can be different sizes. For example, when the center port 322 has an elliptical profile, a first tube portion (e.g., the first tube portion 540) having an elliptical profile may be used. If the center port 322 has an egg-shaped profile, the first tube portion 540 can be replaced without needing to replace the entire filter element 202. This may reduce the cost of manufacturing, as the first endcap 516 and the second tube portion 542 may be used in all filter elements 502, and the first tube portion 540 may be manufactured and installed within the filter element 502 based on the filter head 300 provided with the filtration system. In some embodiments, the first tube portion 540 includes a latch member 548 extending radially from a first portion end 550 of the first tube portion 540, the first portion end 550 being opposite the second pipe end 256.

The first tube portion 540 engages the second endcap flange 529 to prevent axial movement of the first tube portion 540 through the endcap opening 524 in a direction toward the filter head 300 when the filter cartridge 200 is coupled to the filter head 300. The latch member 548 is further positioned between the second endcap flange 529 and the second tube portion 542 (e.g., the support tube 208) to prevent movement of the first tube portion 540 axially relative to the first endcap 516. In some embodiments, the latch member 548 is a first latch member 548 and the first tube portion 540 includes a plurality of latch members positioned circumferentially about the first portion end 550 and configured to engage with the first endcap 516 and the support tube 509 to prevent axial movement of the first tube portion 540.

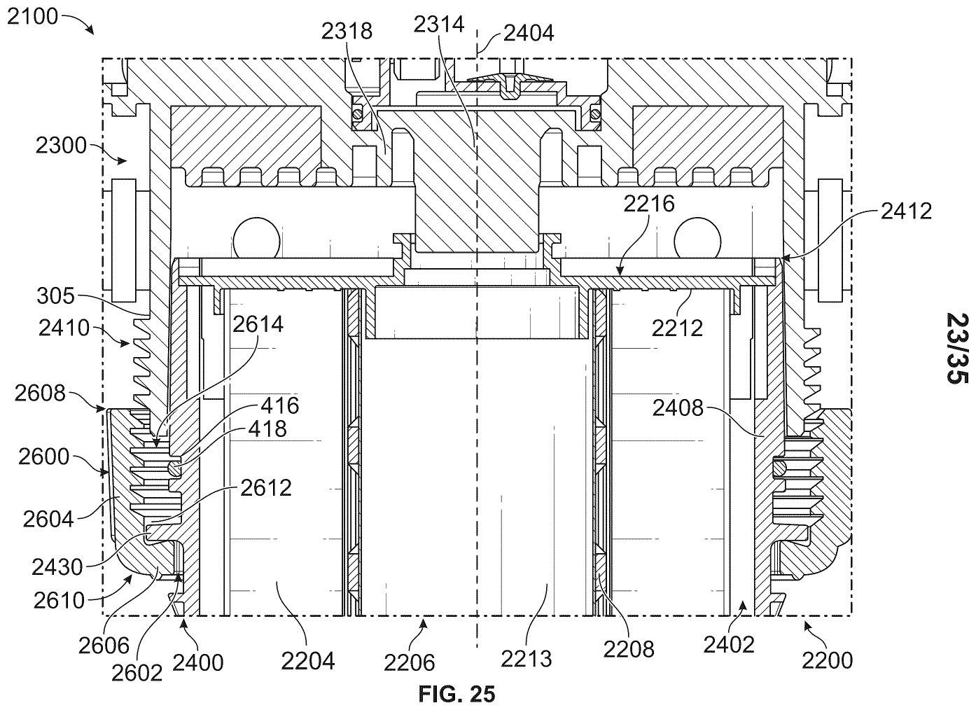

Referring now to FIG. 25, a cross-sectional view of a portion of another example liquid filtration system or filter assembly is shown as system 2100. The system 2100 includes a filter cartridge 2200 and a filter head 2300. The filter cartridge 2200 may be similar to the filter cartridge 200 of the system 100. The filter head 2300 may be similar to the filter head 300 of the system 100. Like features may be labeled with like numbers.

Referring now to FIGS. 25-27, the filter cartridge 2200 includes a filter element 2202 and a shell housing 2400. The filter element 2202 is disposed within a hollow portion 2402 of the shell housing 2400 such that a central axis 2404 of the shell housing 2400 extends through the filter element 2202. The filter element 2202 may be cylindrically-shaped and may include a cylindrically-shaped media pack 2204. The media pack 2204 may be the same as or similar to media pack 204.

The filter element 2202 defines a central opening 2206 extending along a central axis 2210 (e.g., a longitudinal axis, up and down as shown in FIG. 25) of the filter element 2202. In some embodiments, the filter element 2202 is positioned within the shell housing 2400 such that the central axis 2210 of the filter element 2202 is coaxial (e.g., coincident) with the central axis 2404 of the shell housing 2400. A center support tube 2208 is positioned within the media pack 2204 and extends longitudinally along at least a portion of the central opening 2206 from a first, upper end 2212 of the filter element 2202 toward a second, bottom end 2214 of the filter element 2202. In some embodiments, a hydrophobic screen 2209 may be disposed in the center support tube 2208. In some embodiments, a coalescer wrap 2211 may be disposed in the central opening 2206 of the filter element 2202. For example, the coalescer wrap 2211 may surround at least a portion of the center support tube 2208. In some embodiments, the coalescer wrap 2211 and the hydrophobic screen 2209 may be combined together as a VFX tube 2213. The VFX tube 2213 may be disposed in the center support tube 2208 or the central opening 2206 of the filter element 2202. The media pack 2204, and thus the support tube 2208, is concentric with the filter element 2202 and the shell housing 2400. In other words, a central axis of the media pack 2204 is coaxial or substantially coaxial with the central axis 2210 of the filter element 2202 as a whole and the central axis 2404 of the shell housing 2400. As shown in FIG. 25, the support tube 2208 is formed in the shape of a hollow cylinder. An outer wall of the support tube 2208 includes openings in order to allow fluid to pass through the support tube 2208.

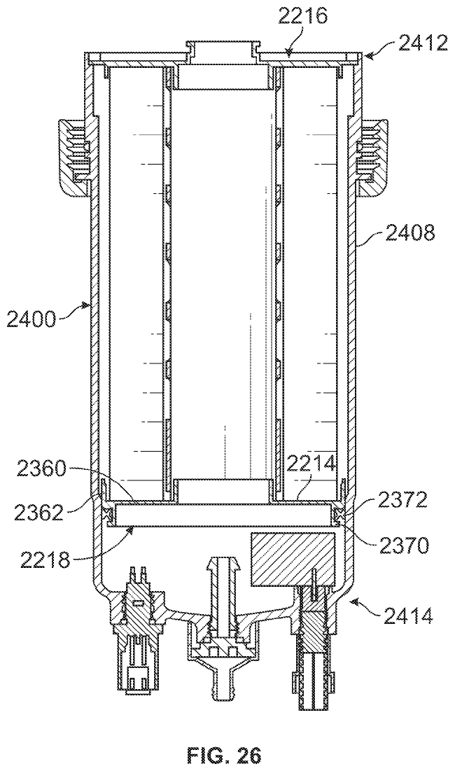

The shell housing 2400 defines a hollow portion 2402 having an inner cross-sectional diameter within which the filter element 2202 is positioned. The shell housing 2400 (e.g., a filter housing, container, or reservoir) includes a sidewall 2408, an upper (e.g., first) shell end 2412, and a lower (e.g., second) shell end 2414. The sidewall 2408 extends between the upper shell end 2412 and the lower shell end 2414 in a substantially concentric orientation relative to the central axis 2404. The shell housing 2400 may be formed from a strong and rigid material. For example, the shell housing 2400 may be formed from a plastic material (e.g., polypropylene, high density polyethylene, polyvinyl chloride, nylon, etc.), a metal (e.g., aluminum, stainless steel, etc.), or another suitable material. The cross-sectional shape of the shell housing 400 may be the same or similar to the cross-sectional shape of the filter element 2202. As shown in FIG. 26, the shell housing 2400 is formed in the shape of a cylinder such that the shell housing 2400 has a generally circular cross-section normal to the central axis 2404 of the shell housing 2400. In other embodiments, the shell housing 2400 may have any other suitable cross-sectional shape; for example, racetrack/obround, oval, rounded rectangular, or another suitable shape.

The sidewall 2408 of the shell housing 2400 includes an inner shell surface 2420 and an outer shell surface 2428. The inner shell surface 2420 defines the hollow portion 2402 of the shell housing 2400. An upper portion of the outer shell surface 2428 may have a smooth (e.g., substantially smooth) surface. For example, the upper portion of the outer shell surface 2428 may have no threads or other projections. The shell housing 2400 further includes an outer groove 416. The outer groove 416 is configured to receive a radial sealing member 418 (e.g., an O-ring, gasket, etc.) that presses against an inner surface of the filter head 2300 (e.g., inner flange surface 2308). The upper portion of the sidewall 2408 may extend from the upper shell end 2412 to the outer groove 416.

The shell housing 2400 further includes a housing projection 2430. The housing projection 2430 at least partially surrounds the shell housing 2400. The housing projection 2430 extends radially outward from the outer shell surface 2420 of the sidewall 2408 of the shell housing 2400. The housing projection 2430 disposed further away from the upper shell end 2412 of the shell housing 2400 than the outer groove 416. As described in more detail herein, the housing projection 2430 facilitates coupling of the filter head 2300 with the shell housing 2400 via a collar engagement.

Referring now to FIGS. 25-29, the filter element 2202 is structured to detachably (e.g., removably) couple to the shell housing 2400 and the filter head 2300. The filter element 2202 includes a first endcap 2216 coupled to the first end 2212 of the filter element 2202 and a second endcap 2218 coupled to the second end 2214 of the filter element 2202. The first endcap 2216 and the second endcap 2218 may be coupled to the media pack 2204 using glue or another suitable bonding agent (e.g., adhesive product) in order to seal the first end 2212 and the second end 2214 of the media pack 2204 and to prevent dirty fluid from bypassing the filter media through the first end 2212 and the second end 2214. In some embodiments, the first endcap 2216 and the second endcap 2218 are coupled to the media pack 2204 without the use of adhesives. For example, a portion of the first endcap 2216 may be heated to a molten state. The media pack 2204 may then be plunged into the molten portion of the first endcap 2216 to seal the media pack 2204 to the first endcap 2216. Similarly, a portion of the second endcap 2218 may be heated to a molten state. The media pack 2204 may then be placed into the molten portion of the second endcap 2218 to seal the media pack 2204 to the second endcap 2218. Coupling the first endcap 2216 and the second endcap 2218 in this way may reduce or eliminate the need for using adhesives, potting, or similar compounds to couple the media pack 2204 to the first endcap 2216 and the second endcap 2218.

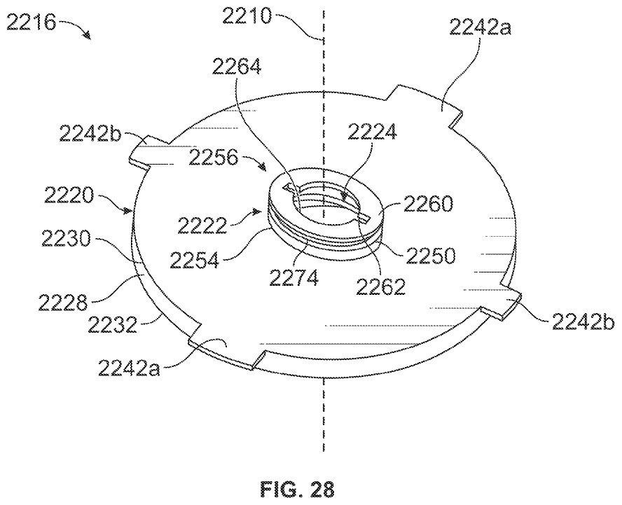

Referring now to FIG. 28, a top perspective view of the first endcap 2216 is shown. The first endcap 2216 includes an annular main body 2220 and a center pipe 2222. The main body 2220 is centered on (e.g., substantially centered on) a central axis 210. The center pipe 2222 extends axially away from the main body 2220 in a direction away from the second endcap 2218. Extending through both the main body 2220 and the center pipe 2222 is an endcap opening 2224 that allows fluid communication between the filter head 2300 and an internal cavity of the media pack 2204. In some embodiments, the center pipe 2222 is centered on the central axis 2210. In some embodiments, the central axis 2210 extends through the center pipe 2222. In some embodiments, the center pipe 2222 is off-center such that the center pipe 2222, and therefore the endcap opening 2224, are not intersected by the central axis 2210.

The first endcap 2216 further includes a first endcap flange 2228 that extends axially from an outer perimeter of the main body 2220. The first endcap flange 2228 is coupled to or integral with the main body 2220 at a first flange end 2230 and terminates away from the main body 2220 at a second flange end 2232. The first endcap flange 2228 extends away from the main body 2220 in a direction opposite to the direction of the center pipe 2222, and in a direction toward the second endcap 2218. The first endcap 2216 further includes at least one support projection 2242. The support projection 2242 extends radially away from the main body 2220 at or proximate to the first flange end 2230. For example, in some embodiments, a top surface of the support projection 2242 may be contiguous with, and in the same plane as, the main body 2220. The support projection 2242 is configured to support the filter element 2202 at a predetermined height within the shell housing 2400 such that a distance between the first end 2212 of the filter element 2202 and the upper shell end 2412 of the shell housing 2400 is controlled to allow proper installation of the filter cartridge 2200 with the filter head 2300.

The first endcap 2216 includes a plurality of support projections 2242. For example, a plurality of support projection 2242 are spaced around a perimeter of the main body 2220 of the first endcap 2216. In some embodiments, the support projections 2242 may have various sizes. For example, a first support projection 2242a may be larger (e.g., wider) than a second support projection 2242b. The first support projection 2242a may be positioned circumferentially away from the second support projection 2242b. As discussed in more detail herein, the support projections 2242 can cooperate or interface with a portion or surface of the shell housing 2400 in an installed configuration to control a position of the first endcap 2216 relative to the upper shell end 2412 of the shell housing 2400 to allow proper installation of the filter cartridge 2200 with the filter head 2300. For example, the different sized support projections 2242 facilitate proper installation based on the support projections 2242 cooperating with a corresponding surface or portion of the shell housing 2400.

The center pipe 2222 of the first endcap 2216 includes a pipe sidewall 2250 that extends circumferentially about the endcap opening 2224. The pipe sidewall 2250 extends from the main body 2220. The pipe sidewall 2250 includes a first pipe end 2254 and a second pipe end 2256, the first pipe end 2254 being coupled to or integral with the main body 2220, and the second pipe end 2256 being positioned away from the main body 2220 opposite the first pipe end 2254. The center pipe 2222 further includes a pipe groove 2274. The pipe groove 2274 is structured to receive a sealing member, such as an O-ring or gasket. The pipe groove 2274 extends at least partially around the endcap opening 2224.

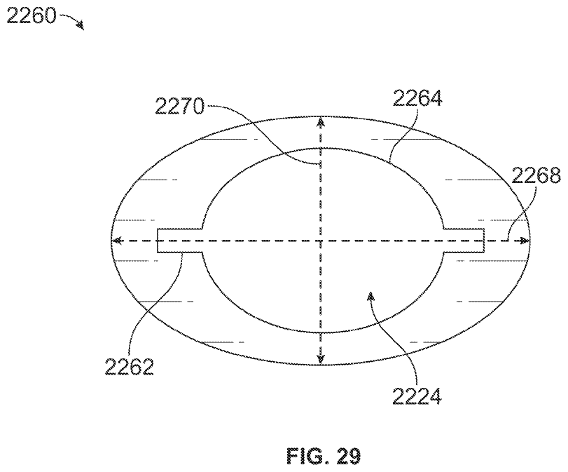

Referring now to FIGS. 28-29, the center pipe 2222 further includes a pipe plate 2260. The pipe plate 2260 is coupled to or integral with the second pipe end 2256. At least a portion of the pipe plate 2260 extends radially inward from the pipe sidewall 2250 and covers a portion of the endcap opening 2224. The pipe plate 2260 defines an alignment element, shown as slot 2262. The slot 2262 may be a rectangular slot. In some embodiments, the slot 2262 may have other shapes. The pipe plate 2260 also defines a plate opening 2264. The plate opening 2264 extends through the pipe plate 2260 and open into the endcap opening 2224 to allow fluid communication between the filter head 2300 and an internal cavity of the media pack 2204.

In some embodiments, the pipe sidewall 2250 defines a substantially circular cross-section when viewed in the direction of the central axis 2210. In some embodiments, the pipe sidewall 2250 may have a similar or same shape as pipe sidewall 250, as shown in FIGS. 2 and 3. For example, the pipe sidewall 2250 may be ovular such that the center pipe 2222 exhibits 180° rotational symmetry. With an ovular shape, the center pipe 2222 has a first, longer length, and a second, shorter length. In some embodiments, the slot 2262 extends along the first, longer length. In other embodiments, the slot 2262 extends along the second, shorter length. In some embodiments, the center pipe 2222 has a different cross-sectional shape that exhibits 180° rotational symmetry, such as a pill, obround, racetrack, ellipse, and the like. In some embodiments, the center pipe 2222 has a cross-sectional shape that exhibits 360° rotational symmetry (e.g., no rotational symmetry), such as an egg shape.

FIG. 29 shows a top-down view of the pipe plate 2260, according to an example embodiment. The pipe plate 2260 includes a major axis 2268 and a minor axis 2270. The slot 2262 extends in a direction that is parallel (e.g., substantially parallel) to the major axis 2268. In some embodiments, the slot 2262 extends in a direction that is parallel to the minor axis 2270.

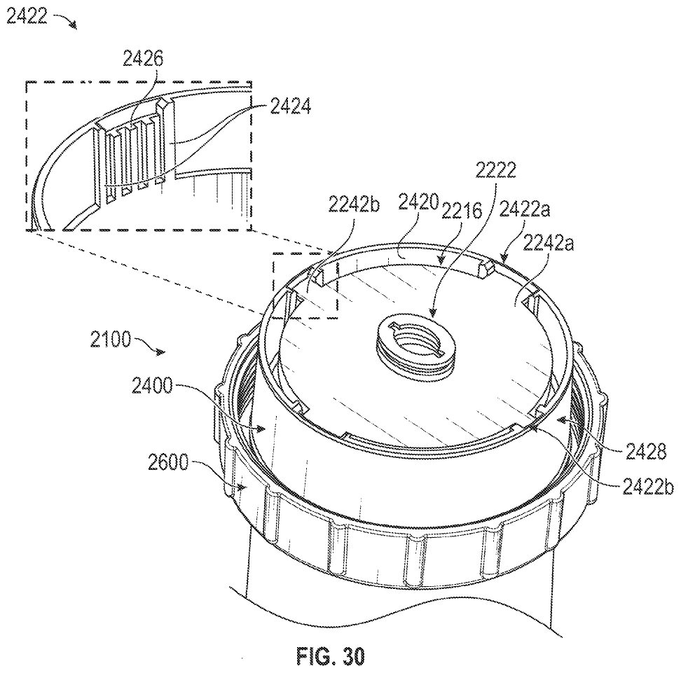

Referring now to FIG. 30, a perspective view of an upper portion of the system 2100 is shown without the filter head 2300, according to an example embodiment. Interrupting the inner shell surface 2420 is at least one endcap locating feature, shown as pocket 2422. The pocket 2422 extends from the upper shell end 2412 toward the lower shell end 2414. The pocket 2422 has a pair of pocket walls 2424. In some embodiments, the pocket 2422 is a recess in the inner shell surface 2420 such that the pair of pocket walls 2424 are formed by the inner shell surface 2420. In some embodiments, the pair of pocket walls 2424 extend radially inward from the inner shell surface 2420 into the hollow portion 2402 of the shell housing 2400.

The pocket 2422 further includes a support surface 2426. The support surface 2426 is structured to cooperate with or interface with a support projection 2242 of the first endcap 2216. For example, when installed, at least a portion of the support projection 2242 is disposed in the pocket 2422 and a bottom surface of the support projection 2242 interfaces with or rests on the support surface 2426 to maintain a desired axial location of the first endcap 2216 relative to the shell housing 2400 and a desired rotational orientation relative to the shell housing 2400 (e.g., prevent unwanted rotation of the first endcap 2216 relative to the shell housing 2400). The first endcap 2216 is coupled with the filter element 2202 such that the pockets 2422 and the support projections 2242 may prevent the filter element 2202 from rotating relative to the shell housing 2400.

The shell housing 2400 may include a plurality of pockets 2422. For example, the system 2100 of FIG. 30 has four pockets 2422. In some embodiments, the pockets 2422 may have different sizes to accommodate different support projections 2242. For example, a first pocket 2242a may be structured to receive a first support projection 2242a and a second pocket 2242b may be structured to receive a second support projection 2242b that is smaller than the first support projection 2242a. The different sized pockets 2422 help facilitate proper installation of the first endcap 2216 by ensuring the support projections 2242 align with corresponding pocket 2422. The first endcap 2216 can be disposed in the shell housing 2400 such that the sidewall 2408 surrounds the first endcap 2216. The main body 2220 of the first endcap 2216 may be disposed below the upper shell end 2412 of the shell housing 2400.

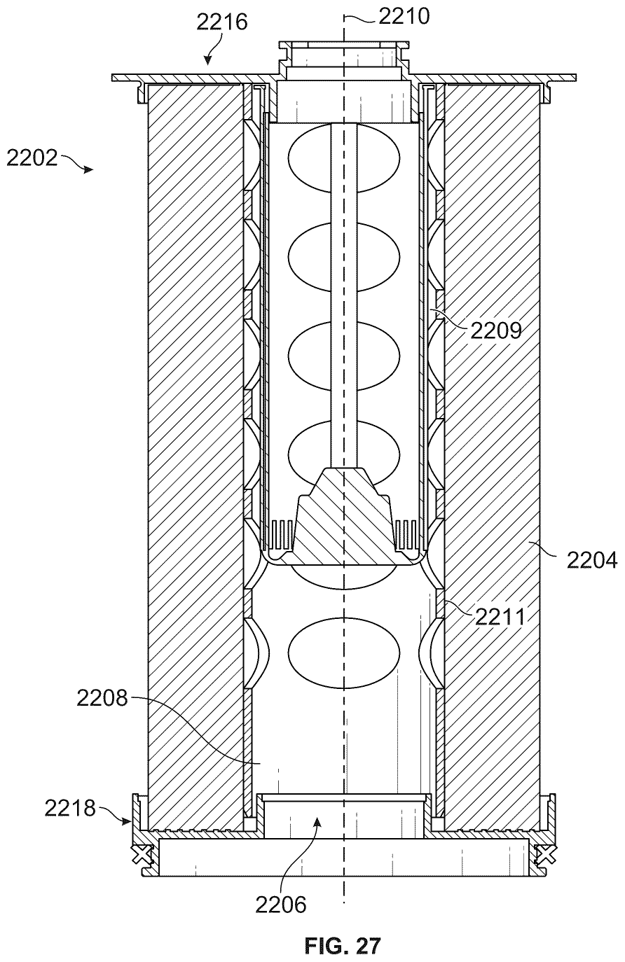

Referring back to FIGS. 26 and 27, the second endcap 2218 includes a includes a main endcap body 2360 having an endcap flange 2362 that extends axially from a perimeter of the main endcap body 2360 in a direction toward the first endcap 2216. The second endcap 218 further includes a retainer element, shown as retainer flange 2370. The retainer flange 2370 extends axially from the main endcap body 2360 in a direction away from the first endcap 2216. The retainer flange 2370 is disposed radially inward from the perimeter of the main endcap body 2360. The retainer flange 2370 is structured to receive a sealing member 2372 (e.g., an O-ring or a gasket) to create a seal between the second endcap 2218 and the shell housing 2400. In some embodiments, the sealing member 2372 is an H-seal.

The retainer element 2370 is coupled to and extends radially from the endcap flange 2362 in a direction away from the central axis 2210. The retainer element 2370 is structured to engage a portion of the shell housing 2400 when the filter element 2202 is positioned within the shell housing 2400. The retainer element 2370 is configured to engage a retainer projection 374 (FIG. 11) of the shell housing 2400. The retainer element 2370 and the retainer projection 374 cooperate, in some embodiments, to prevent rotation of the filter element 2202 relative to the shell housing 2400 about the central axis 2404.

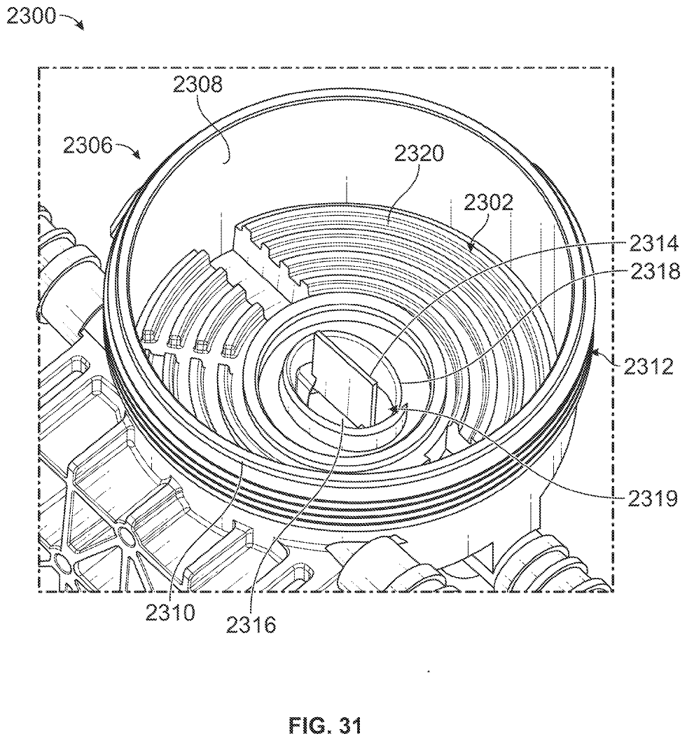

Referring now to FIGS. 25, 31, and 32, the filter head 2300 includes a base 2302. The filter head 2300 further includes an outer flange 2306 that extends from an outer perimeter of the base 2302. The outer flange 2306 includes an inner flange surface 2308 and an outer flange surface 2310. The outer flange 2306 is structured to surround, at least partially, the shell housing 2400. For example, the inner flange surface 2308 may interface with the upper portion of the outer shell surface 2428. In some embodiments, the inner flange surface 2308 may be a substantially smooth surface such that inner flange surface 2308 can slide along the outer shell surface 2428 such that the filter head 2300 can slide onto the shell housing 2400. The outer flange surface 2310 includes a threaded portion, shown as male threaded portion 2312. For example, the male threaded portion 2312 is disposed on the outer flange surface 2310 of the filter head 2300.

The filter head 2300 further includes an engagement element 2314. The engagement element 2314 extends from the base 2302 of the filter head 2300 in the same direction as the outer flange 2306. The engagement element 2314 is structured to engage with the slot 2262 of the first endcap 2216. For example, the engagement element 2314 may be a rectangular tab or key. At least a portion of the engagement element 2314 is configured to extend into the slot 2262 with the filter head 2300 properly aligned with the shell housing 2400. The engagement element 2314 may have any shape configured to correspond with the shape of the slot 2262. The engagement element 2314 facilitates proper installation and alignment of the filter head 2300 with the first endcap 2216 and the shell housing 2400. In some embodiments, the shell housing 2400 and the filter head 2300 may have corresponding markings on exterior surfaces to facilitate alignment of the engagement element 2314 and the slot 2262.

The filter head 2300 further includes a head opening 2316. The head opening 2316 is in the base 2302 of the filter head 2300. In some embodiments, the engagement element 2314 may extend from a first side of the head opening 2316 to a second side of the head opening 2316. For example, the engagement element 2314 may bisect the head opening 2316. An inner wall 2318 surrounds the head opening 2316 and the engagement element 2314. The inner wall 2318 may have a shape that corresponds with the shape of the center pipe 2222. For example, the inner wall 2318 may have a non-circular shape (e.g., an oval shape). The inner wall 2318 extends from the base 2302 in the same direction as the outer flange 2306. The inner wall 2318 defines a cavity 2319 to receive at least a portion of the center pipe 2222 and the pipe plate 2260 in the installed position. A portion of the center pipe 2222 can be disposed between the inner wall 2318 and the engagement element 2314.

The filter head 2300 may further include a plurality of base ribs 2320. The base ribs 2320 extend from the base 2302 in the same direction as the outer flange 2306. The base ribs 2320 are disposed between the outer flange 2306 and the inner wall 2318. The base ribs 2320 may be concentric with the center of the base 2302.

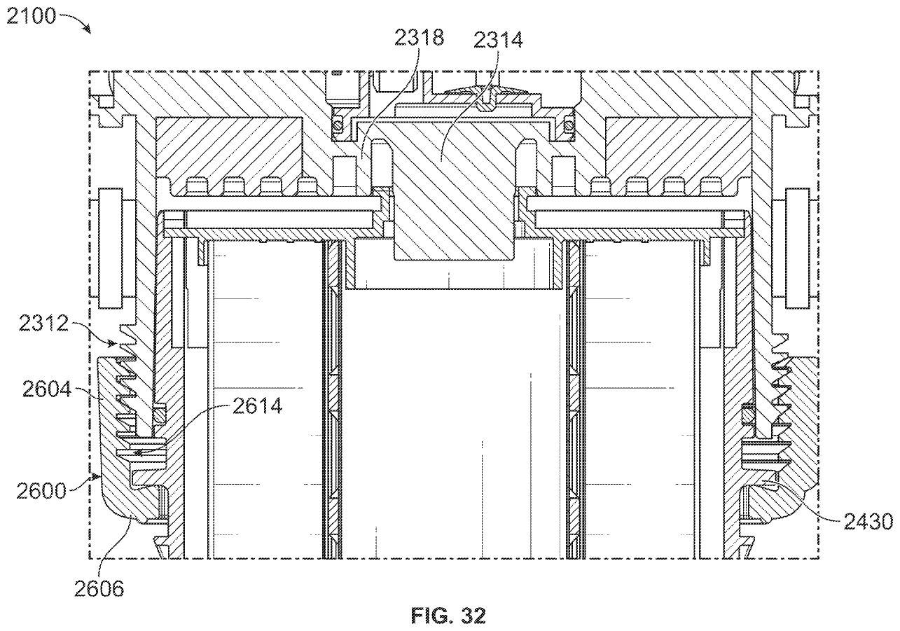

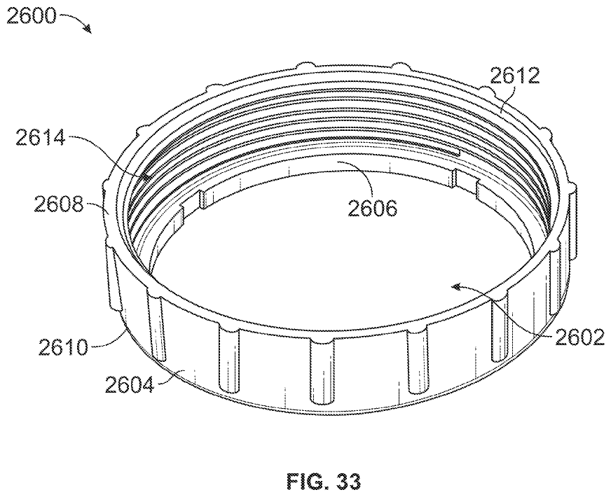

Referring now to FIGS. 25, 32, and 33, the system 2300 includes a collar 2600. The filter cartridge 2200 of the system 2100 can be coupled to the filter head 2300 via the collar 2600. FIG. 25 depicts the system 2300 prior to the collar 2600 engaging with the filter head 2300. FIG. 32 depicts the system 2300 with the collar 2600 at least partially engaged with the filter head 2300. The collar 2600 is configured to surround at least a portion of a shell housing 2400 in an installed position. The collar 2600 defines a collar opening 2602. The collar opening 2602 is configured to receive the shell housing 2400 such that the shell housing 2400 extends through the collar opening 2602.

The collar 2600 includes a collar sidewall 2604 and a collar base 2606. The collar sidewall 2604 extends substantially in an axial direction along an outer surface of the sidewall 2408 of the shell housing 2400 in an installed position. The collar sidewall 2604 has a first collar end 2608 and a second collar end 2610. The first collar end 2608 is configured to be disposed closer to the upper shell end 2412 of the shell housing 2400 than the second collar end 2610. The collar base 2606 extends substantially radially inward from the collar sidewall 2604 in a direction toward the collar opening 2602. The collar base 2606 extends from the collar sidewall 2604 at or proximate to the second collar end 2610. The collar sidewall 2604 has an inner collar surface 2612. The inner collar surface 2612 includes a female threaded portion 2614. For example, the female threaded portion 2614 is disposed on the inner collar surface 2612.

The housing projection 2430 is configured to interface with the collar base 2606 to facilitate the coupling of the filter head 2300 with the shell housing 2400. For example, a top surface of the collar base 2606 can interface with a bottom surface of the housing projection 2430. The housing projection 2430 can prevent axial movement of the collar 2600 in a direction toward the upper shell end 2412 of the shell housing 2400. The collar 2600 is configured to rotate around the shell housing 2400 with the shell housing 2400 disposed in the collar opening 2602.

As an illustrative example, to assemble the system 2100, the filter cartridge 2200 is disposed in the hollow portion 2402 of the shell housing 2400. A first endcap 2216 is disposed at or proximate to an upper shell end 2412 of the shell housing 2400. A support projection 2242 of the first endcap 2216 is disposed in a pocket 2422 of the shell housing 2400. With the support projection 2242 in the pocket 2422, the first endcap 2216 may not rotate relative to the shell housing 2400.

The collar 2600 is disposed around the shell housing 2400. The filter head 2300 is disposed on the shell housing 2400. For example, the outer flange 2306 is disposed around the upper shell end 2412 of the shell housing 2400. The engagement element 2314 of the filter head 2300 is aligned with the slot 2262 of the first endcap 2216. The engagement element 2314 engages (e.g., slides into) the slot 2262 before the male thread portion 2312 of the filter head 2300 engages the female thread portion 2614 of the collar 2600. The engagement element 2314 prevents rotation of the filter head 2300 relative to the shell housing 2400.

The collar 2600 rotates around the shell housing 2400 to couple the filter head 2300 with the shell housing 2400 and retain the filter cartridge 2200 in the shell housing 2400. For example, the collar base 2606 interfaces with the housing projection 2430. As the collar 2600 rotates, the engagement between the female thread portion 2614 of the collar 2600 and the male thread portion 2312 of the filter head 2300 pulls the base 2302 of the filter head 2300 closer to the upper shell end 2412 of the shell housing 2400 until secured.

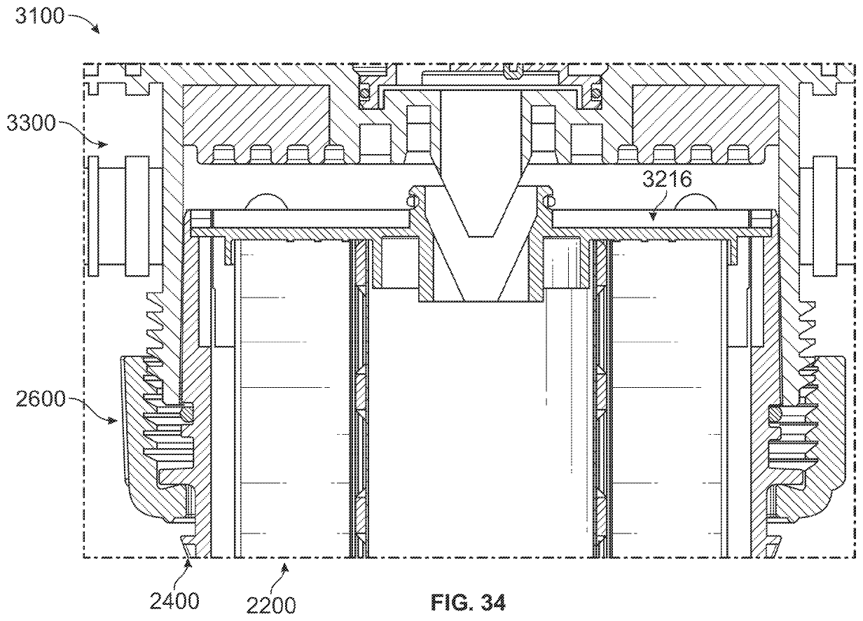

Referring to FIG. 34, a cross-sectional view of a portion of another example liquid filtration system or filter assembly is shown as system 3100. System 3100 includes the filter cartridge 2200, the shell housing 2400, and the collar 2600 of system 2100, or portions thereof. The system 3100 further includes a first endcap 3216 and a filter head 3300. Assembly of system 3100 is similar to the assembly of system 2100.

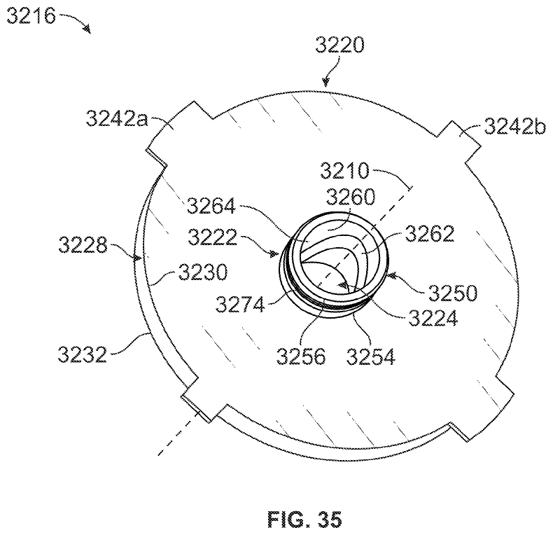

Referring now to FIG. 35, a top perspective view of the first endcap 3216 is shown. The first endcap 3216 includes an annular main body 3220 and a center pipe 3222. The main body 3220 is centered on (e.g., substantially centered on) a central axis 3210. The center pipe 3222 extends axially away from the main body 3220 in a direction away from the second endcap 2218. Extending through both the main body 3220 and the center pipe 3222 is an endcap opening 3224 that allows fluid communication between the filter head 3300 and an internal cavity of the media pack 2204. In some embodiments, the center pipe 3222 is centered on the central axis 3210. In some embodiments, the central axis 3210 extends through the center pipe 3222. In some embodiments, the center pipe 3222 is off-center such that the center pipe 3222, and therefore the endcap opening 3224, are not intersected by the central axis 3210.

The first endcap 3216 further includes a first endcap flange 3228 that extends axially from an outer perimeter of the main body 3220. The first endcap flange 3228 is coupled to or integral with the main body 3220 at a first flange end 3230 and terminates away from the main body 3220 at a second flange end 3232. The first endcap flange 3228 extends away from the main body 3220 in a direction opposite to the direction of the center pipe 3222, and in a direction toward the second endcap 2218.

The first endcap 3216 further includes at least one support projection 3242. The support projection 3242 extends radially away from the main body 3220 at or proximate to the first flange end 3230. For example, in some embodiments, a top surface of the support projection 3242 may be contiguous with, and in the same plane as, the main body 3220. The support projection 3242 is configured to support the filter element 2202 at a predetermined height within the shell housing 2400 such that a distance between the first end 2212 of the filter element 2202 and the upper shell end 2412 of the shell housing 2400 is controlled to allow proper installation of the filter cartridge 2200 with the filter head 2300.

The first endcap 3216 may include a plurality of support projections 3242. For example, a plurality of support projections 3242 may be spaced around a perimeter of the main body 3220 of the first endcap 3216. In some embodiments, the support projections 3242 have various sizes. For example, a first support projection 3242a may be larger (e.g., wider) than a second support projection 3242b. The first support projection 3242a may be positioned circumferentially away from the second support projection 3242b. As discussed in more detail herein, the support projections 3242 can be configured to cooperate or interface with a portion or surface of the shell housing 2400 in an installed configuration to control a position of the first endcap 3216 relative to the upper shell end 2412 of the shell housing 2400 to allow proper installation of the filter cartridge 2200 with the filter head 3300. For example, the different sized support projections 3242 can facilitate proper installation based on each support projection 3242 cooperating with a corresponding surface or portion of the shell housing 2400. For example, similar to first endcap 2216, the support projections 3242 may be disposed in a pocket 2422 of the shell housing 2400 to prevent rotation of the first endcap 3216, and therefore rotation of the filter cartridge 2200.

The center pipe 3222 of the first endcap 3216 includes a pipe sidewall 3250 that extends circumferentially about the endcap opening 3224. The pipe sidewall 3250 extends from the main body 3220. The pipe sidewall 3250 includes a first pipe end 3254 and a second pipe end 3256, the first pipe end 3254 being coupled to or integral with the main body 3220, and the second pipe end 3256 being positioned away from the main body 3220 opposite the first pipe end 3254. The center pipe 3222 further includes a pipe groove 3274. The pipe groove 3274 is structured to receive a sealing member, such as an O-ring or gasket. The pipe groove 3274 extends at least partially around the endcap opening 3224.

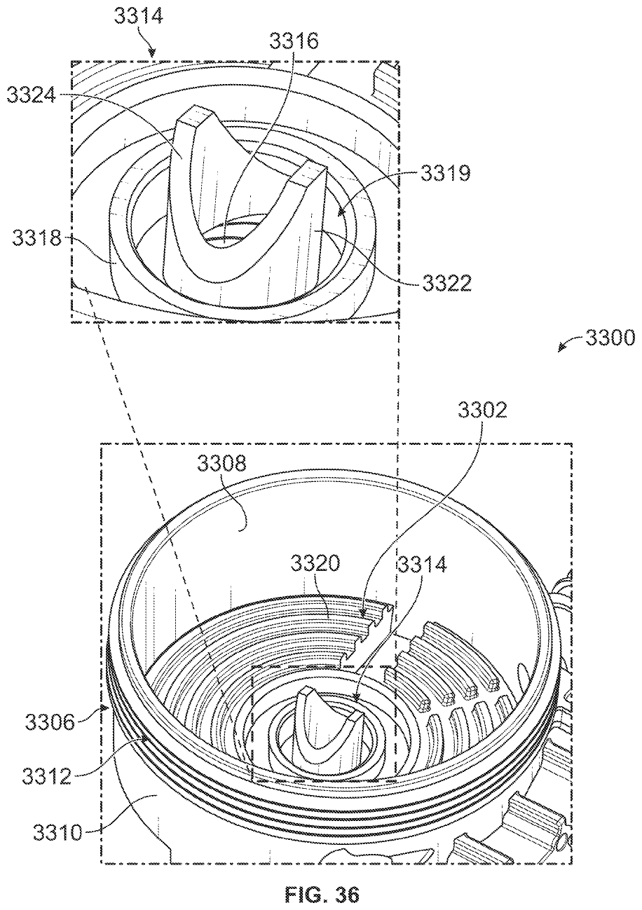

Referring now to FIGS. 34-35, the center pipe 3222 further includes an alignment element 3260. The alignment element 3260 extends inwardly from the pipe sidewall 3250 into the endcap opening 3224. In some embodiments, the alignment element 3260 extends radially inward from the pipe sidewall 3250 and may extend axially along the pipe sidewall 3250. For example, the alignment element 3260 may comprise an alignment projection 3262 that defines a vertical slot 3264. The alignment projection 3262 is the portion of the alignment element 3260 that extends radially inward from the pipe sidewall 3250. The alignment projection 3262 can define the vertical slot 3264 that is configured to receive a portion of a corresponding engagement element (e.g., the element body 3322 of the engagement element 3322 of the filter head 3300, as discussed with reference to FIG. 36). The alignment element 3260 can facilitate proper alignment of other components of the system 3100 with the filter element 2202. The alignment element 3260 can also act as a disengagement feature. For example, the alignment element 3260 can help prevent the filter element 2202 from remaining coupled to the other components (e.g., a filter head 3300) when the shell housing 2400 is removed for service.

In some embodiments, the pipe sidewall 3250 defines a substantially circular cross-section when viewed in the direction of the central axis 3210. In some embodiments, the pipe sidewall 3250 may have a similar or same shape as pipe sidewall 2250, as shown in FIGS. 2 and 3. For example, the pipe sidewall 3250 may be ovular such that the center pipe 3222 exhibits 180° rotational symmetry. With an ovular shape, the center pipe 3222 has a first, longer length, and a second, shorter length. In some embodiments, the center pipe 3222 has a different cross-sectional shape that exhibits 180° rotational symmetry, such as a pill, obround, racetrack, ellipse, and the like. In some embodiments, the center pipe 3222 has a cross-sectional shape that exhibits 360° rotational symmetry (e.g., no rotational symmetry), such as an egg shape.

Referring now to FIGS. 34-37, the filter head 3300 includes a base 3302. The filter head 3300 further includes an outer flange 3306 that extends from an outer perimeter of the base 3302. The outer flange 3306 includes an inner flange surface 3308 and an outer flange surface 3310. The outer flange 3306 is structured to surround, at least partially, the shell housing 2400. For example, the inner flange surface 3308 may interface with the upper portion of the outer shell surface 2428. In some embodiments, the inner flange surface 3308 may be a substantially smooth surface such that inner flange surface 3308 can slide along the outer shell surface 2428 such that the filter head 3300 can slide onto the shell housing 2400.

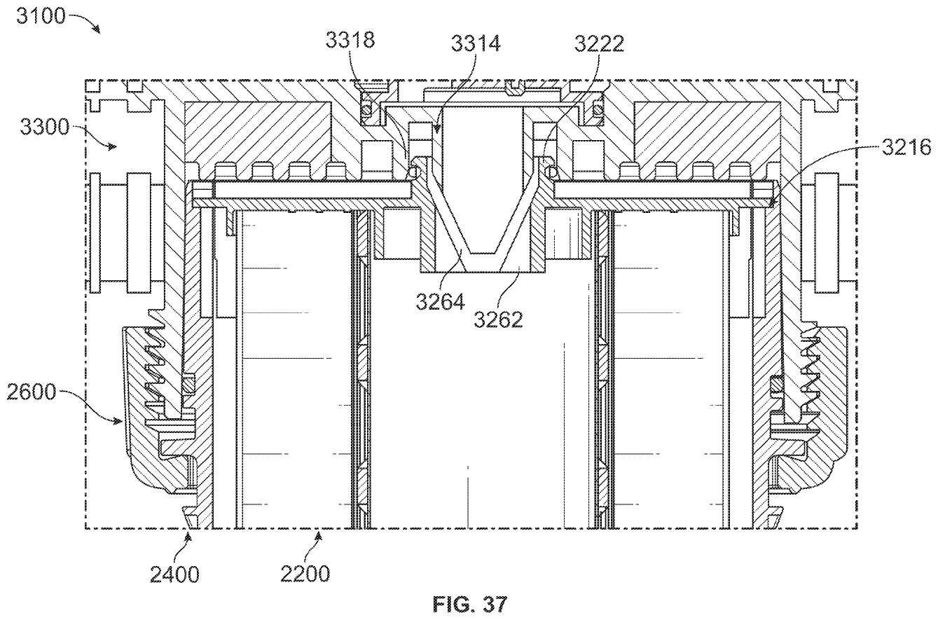

The outer flange surface 3310 includes a threaded portion, shown as male threaded portion 3312. For example, the male threaded portion 3312 is disposed on the outer flange surface 3310 of the filter head 3300. The male threaded portion 3312 is structured to interface with the female threaded portion 2614 of the collar 2600. FIG. 34 depicts the system 2300 prior to the collar 2600 engaging with the filter head 2300. FIG. 37 depicts the system 2300 with the collar 2600 at least partially engaged with the filter head 2300.

The filter head 3300 further includes an engagement element 3314. The engagement element 3314 extends from the base 3302 of the filter head 3300 in the same direction as the outer flange 3306. The engagement element 3314 is structured to engage with the alignment element 3260 of the first endcap 3216. For example, at least a portion of the engagement element 3314 can extend into center pipe 3222 and interface with the alignment element 3260. A portion of the engagement element 3314 extends into the vertical slot 3264 defined by the alignment element 3260. The engagement element 3314 may have a shape or contour that corresponds with the alignment element 3260 such that engagement facilitates proper alignment of the filter head 3300 with the filter element 2202 and therefore the shell housing 2400. For example, the engagement element 3314 has an element body 3322 that has a cylindrical shape to be disposed in the center pipe 3222. In some embodiments, the element body 3322 has an oval cross-sectional shape to align with an oval center pipe 3222. The engagement element 3314 can also act as a disengagement feature. For example, the engagement element 3314 can help prevent the filter element 2202 from remaining coupled to the filter head 3300 when the shell housing 2400 is removed for service.

The element body 3322 has at least one cutout 3324 that corresponds with the alignment projection 3262. The element body 3322 can be structured to be disposed in the vertical slot 3264 defined by the alignment element 3260. The engagement element 3314 may have any shape configured to correspond with the shape of the alignment element 3260. In some embodiments, the shell housing 2400 and the filter head 3300 may have corresponding markings on exterior surfaces to facilitate alignment of the engagement element 3314 and alignment element 3260.

The filter head 3300 further includes a head opening 3316. The head opening 3316 is in the base 3302 of the filter head 3300. In some embodiments, the engagement element 3314 at least partially surrounds the head opening 3316. An inner wall 3318 surrounds the head opening 3316 and the engagement element 3314. The inner wall 3318 may have a shape that corresponds with the shape of the center pipe 3222. For example, the inner wall 3318 may have a non-circular shape (e.g., an oval shape). The inner wall 3318 extends from the base 3302 in the same direction as the outer flange 3306. The inner wall 3318 defines a cavity 3319 to receive at least a portion of the center pipe 3222 in the installed position. As shown in FIG. 37, a portion of the center pipe 3222 can be disposed between the inner wall 3318 and the engagement element 3314.

The filter head 3300 may further include a plurality of base ribs 3320. The base ribs 3320 may extend from the base 3302 in the same direction as the outer flange 3306. The base ribs 3320 may be disposed between the outer flange 3306 and the inner wall 3318. The base ribs 3320 may be concentric with the center of the base 3302.

As utilized herein with respect to numerical ranges, the terms “approximately,” “about,” “substantially,” and similar terms generally mean+/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “first,” “second,” “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

1. A filtration system comprising:
a filter head comprising:
an outer flange; and
a center port; and
a filter cartridge comprising:
a shell housing configured for coupling to the filter head; and
a filter element positioned within the shell housing, the filter element comprising filter media and an endcap coupled to the filter media, the endcap comprising:
a center pipe; and
an alignment projection extending radially inward from an inner surface of the center pipe;
wherein the alignment projection is configured to engage with a portion of the filter head to prevent the center pipe from rotating while the shell housing is being coupled to the filter head; and
wherein the center pipe and the center port are aligned when the alignment projection is engaged with the portion of the filter head.

2. The filtration system of claim 1, wherein the filter head further comprises an alignment post extending axially from the filter head in the same direction as the center port, the alignment post positioned radially within the center port, the alignment post being the portion of the filter head configured to engage the alignment projection.

3. The filtration system of claim 2, wherein the alignment post has an axial post height that is greater than an axial port height of the center port.

4. The filtration system of claim 1, wherein:
the center port of the filter head has a first non-circular profile; and
the center pipe of the endcap has a second non-circular profile similar to the first non-circular profile of the filter head such that the center pipe is configured to be positioned within the center port.

5. The filtration system of claim 4, wherein the first non-circular profile and the second non-circular profile are elliptical and have a rotational symmetry of 180 rotational degrees.

6. The filtration system of claim 4, wherein the first non-circular profile and the second non-circular profile are non-circular, non-elliptical, and do not have rotational symmetry.

7. A filter element comprising:
filter media having a first media end and a second media end opposite the first media end;
a first endcap coupled to the first media end and a second endcap coupled to the second media end;
a center pipe extending axially from the first endcap in a direction opposite the second media end, the center pipe comprising:
a pipe sidewall extending circumferentially about a central opening; and
an alignment projection extending radially from the pipe sidewall into the central opening.

8. The filter element of claim 7, wherein:
the center pipe includes an elliptical profile having a major axis and a minor axis; and
the alignment projection extends in a direction substantially parallel to one of the major axis and the minor axis.

9. The filter element of claim 7, wherein the alignment projection includes a concave engagement surface configured to engage a portion of a filter head.

10. A filtration system comprising:
a filter head comprising:
an outer flange; and
an engagement element;
a filter cartridge comprising:
a shell housing comprising a pocket; and
a filter element positioned within the shell housing, the filter element comprising filter media and an endcap coupled to the filter media, the endcap comprising:
a main body;
a support projection extending from a perimeter of the main body positionable within the pocket of the shell housing so as to prevent rotation of the filter element relative to the shell housing; and
an alignment element disposed radially inward from the perimeter of the main body, the alignment element structured to engage with at least a portion of the engagement element of the filter head to prevent rotation of the filter head relative to the filter element; and
a collar configured to couple the filter head with the filter cartridge.

11. The filtration system of claim 10, wherein the endcap further comprises:
a center pipe extending from the main body;
a pipe plate disposed at an end of the center pipe, the pipe plate comprising the alignment element, the alignment element configured to receive at least the portion of the engagement element of the filter head.

12. The filtration system of claim 11, wherein the engagement element comprises a rectangular tab and the alignment element comprises a slot to receive the rectangular tab.

13. The filtration system of claim 11, wherein the engagement element comprises an element body and a cutout and the alignment element comprises an alignment projection and a vertical slot, the element body disposable in the vertical slot and the cutout to correspond with the alignment projection.

14. The filtration system of claim 10, wherein
the filter head further comprises:
a base, wherein the outer flange extends in a direction from the base and the engagement element extends from the base in the same direction as the outer flange; and
a first thread portion disposed on an outer surface of the outer flange; and
the collar comprises a second thread portion engageable with the first thread portion to couple the filter head with the filter cartridge.

15. The filtration system of claim 10, wherein the endcap comprises a plurality of support projections, including the support projection, the plurality of support projections comprising a first support projection that is larger than a second support projection.

16. The filtration system of claim 15, wherein the shell housing comprises a plurality of pockets including the pocket, the plurality of pockets comprising a first pocket corresponding to the first support projection and a second pocket corresponding to the second support projection.

17. The filtration system of claim 10, wherein:
the shell housing comprises an outer housing surface; and
the outer flange of the filter head comprises an inner flange surface and an outer flange surface, the inner flange surface structured to extend along the outer housing surface and the outer flange surface structured to engage with the collar.

18. The filtration system of claim 10, wherein:
the filter head further comprises a first thread portion;
the collar comprises a second thread portion engageable with the first thread portion; and
the engagement element is configured to engage with the alignment element prior to the first thread portion engaging with the second thread portion.

19. The filtration system of claim 10, wherein:
the endcap further comprises a center pipe extending from the main body; and
the filter head further comprises:
a base, wherein the outer flange extends in a direction from the base; and
an inner wall extending in the same direction from the base, the inner wall surrounding the engagement element and defining a cavity to receive at least a portion of the center pipe.

20. The filtration system of claim 10, wherein:
the endcap further comprises a center pipe extending from the main body; and
the filter head further comprises an inner wall surrounding the engagement element, at least a portion of the center pipe positionable between the inner wall and the engagement element in an assembled configuration.

21. The filtration system of claim 19, wherein the center pipe comprises a non-circular shape, and the inner wall comprises a corresponding non-circular shape.

22. A filter element comprising:
filter media having a first media end and a second media end opposite the first media end;
a first endcap coupled to the first media end and a second endcap coupled to the second media end;
a center pipe extending axially from the first endcap in a direction opposite the second media end, the center pipe comprising:
a pipe sidewall extending circumferentially about a central opening; and
a pipe plate disposed at an end of the pipe sidewall, the pipe plate extending radially inward from the pipe sidewall into the center opening, the pipe plate defining an alignment feature.

23. The filter element of claim 22, wherein the alignment feature comprises a rectangular slot configured to receive a corresponding engagement feature of a filter head.

24. The filter element of claim 22, wherein the first endcap comprises a plurality of support projections extending radially outward from the first endcap, the plurality of support projections disposable in a pocket of a shell housing.

25. The filter element of claim 24, wherein the plurality of support projections comprises a first support projection and a second support projection, the first support projection being larger than the second support projection.
